(19) United States
(12) Patent Application Publication
(10) Pub. No.: US 2008/0151400 A1
(43) Pub. Date: Jun. 26, 2008

(54) Adjustable Blind-Spot and Security/Privacy Mirrors

(76) Inventor: Sol A. Gonzalvo, Salinas, CA (US)

Correspondence Address: CENTRAL COAST PATENT AGENCY, INC, 3 HANGAR WAY SUITE D, WATSONVILLE, CA, 95076, US

(21) Appl. No.: 11/953,974

(22) Filed: Dec. 11, 2007

Related U.S. Application Data
(60) Provisional application No. 60/874,345, filed on Dec. 12, 2006.
(60) Provisional application No. 61/000,065, filed on Oct. 22, 2007.

(51) Int. Cl. G02B 5/08

(52) U.S. Cl. 359/862

(57) ABSTRACT

A utility mirror assembly has a base having a base surface with an adhesive layer for contacting and adhering to a second surface, a post, adjustable in length, congruent with the base and extending substantially orthogonally away from the base surface, and a utility mirror having a reflective surface, incorporated in a frame attaching to the post at an end of the post away from the base by a limited universal pivot mechanism, allowing a range of angular adjustment between the utility mirror and the base surface.

### CROSS-REFERENCE TO RELATED APPLICATIONS

The present invention claims priority to Provisional Patent Application 60/874,345 filed on Dec. 12, 2006, and to Provisional Patent Application 61/000,065, filed on Oct. 22, 2007, and the disclosure of both applications is incorporated herein at least by reference. The present invention is also related to U.S. patent application Ser. No. 10/791,225, filed on Mar. 2, 2004, now abandoned, and the entire disclosure of that application is also incorporated herein at least by reference.

### BACKGROUND OF THE INVENTION

1. Field of the Invention

The present invention is in the technical area of reflective devices, and pertains more particularly to adjustable mirrors used for blind-spot elimination in automobile applications, and for privacy and security needs in work situations.

2. Description of Related Art

There is a great deal of prior art in the technical area of mirrors for various applications, but there are always unmet needs and room for improvement. The present inventor has addressed some of these needs and provides inventions that enhance and improve mirrors used for blind-spot elimination in vehicles, and for mirrors used, particularly with computer systems, in workplace situations.

In a modern workplace workers often use computers, having display monitors, for accomplishing specific work-related tasks. In many such situations, a worker's monitor may display drawings or text documents that are proprietary, and should thus be screened from unauthorized viewing. Typically-however, a worker is closely focused on the display monitor, and the presence of another person in the same cubicle, such as behind the worker viewing the monitor, would not be readily noticeable. If, however, a suitable small mirror were provided, in line of sight of the worker, that worker would be alerted to the new presence of a perhaps unauthorized person, and would be able to take immediate steps to shield proprietary information from the unauthorized person.

### BRIEF SUMMARY OF THE INVENTION

A utility mirror assembly is provided, comprising a base having a base surface with an adhesive layer for contacting and adhering to a second surface, a post, adjustable in length, congruent with the base and extending substantially orthogonally away from the base surface, and a utility mirror having a reflective surface, incorporated in a frame attaching to the post at an end of the post away from the base by a limited universal pivot mechanism, allowing a range of angular adjustment between the utility mirror and the base surface.

In one embodiment the second surface is a reflective surface of a rear-view mirror of a vehicle, and the utility mirror provides for viewing a blind spot not viewable in the reflective surface without angular adjustment of the reflective surface. Also in one embodiment the utility mirror has curvature for one or both of focus or magnification.

In some embodiments the adjustable post is adjustable in length through an internally-threaded first portion engaging and externally-threaded second portion, and further comprises a locking mechanism for locking at a set length. In some other embodiments the adjustable post is adjustable in length through a first portion having an internal bore of a first diameter, and a second portion with a post of substantially the diameter of the bore, the second portion engaging the bore, and further comprises a locking mechanism for locking at a set length.

In another aspect the second surface is a body surface or screen of a computer monitor, the utility mirror providing an adjustable view to the rear for a person viewing the computer display monitor. In some embodiments the post may have an L-shape, such that the mirror assembly may be mounted on a side body surface of the display monitor, yet allowing direct viewing by the user viewing the monitor. Also in some embodiments the post may have a C-shape, such that the mirror assembly may be mounted on a back body surface of the display monitor, yet allowing direct viewing by the user viewing the monitor.

In some embodiments the adhesive layer comprises a male or female Velcro™ surface for mating with another Velcro™ surface. Also in some embodiments one or both of the reflective surface of the rear-view mirror and the utility mirror are angularly adjustable through remotely operated, motor-driven mechanisms. Also the rear-view mirror may be one of a driver-side, a passenger side, or an internal rear-view mirror.

### BRIEF DESCRIPTION OF THE SEVERAL VIEWS OF THE DRAWINGS

FIG. 1 and FIG. 2 show a rear view mirror with a blind-spot mirror according to an embodiment of the present invention.

FIGS. 2, 3 and 4 show details of adjustable mounting mechanism for the mirrors of FIGS. 1 and 2.

FIG. 5 is another view of a side-view mirror with a mirror according to an embodiment of the invention.

FIGS. 6-13 illustrate various views of apparatus for mounting a blind-spot mirror.

FIGS. 14-28 illustrate various views of apparatus pertaining to a blind-spot mirror mounted into a side-view mirror for a vehicle.

FIG. 29-31 pertain to a switching mechanism for folding a blind-spot mirror in an embodiment.

FIGS. 32-39 illustrate various aspects of a blind-spot mirror and mounting in an alternative embodiment.

FIGS. 40-99 pertain to various aspects of privacy and security mirrors for computer systems and display monitors.

### DETAILED DESCRIPTION OF THE INVENTION

FIG. 1 is an illustration of a rear view mirror device 12 according to an embodiment of the present invention. In this embodiment the device is attached to a glass 11 of a standard driver-side mirror 10 and in FIG. 5 to a standard passenger side mirror.

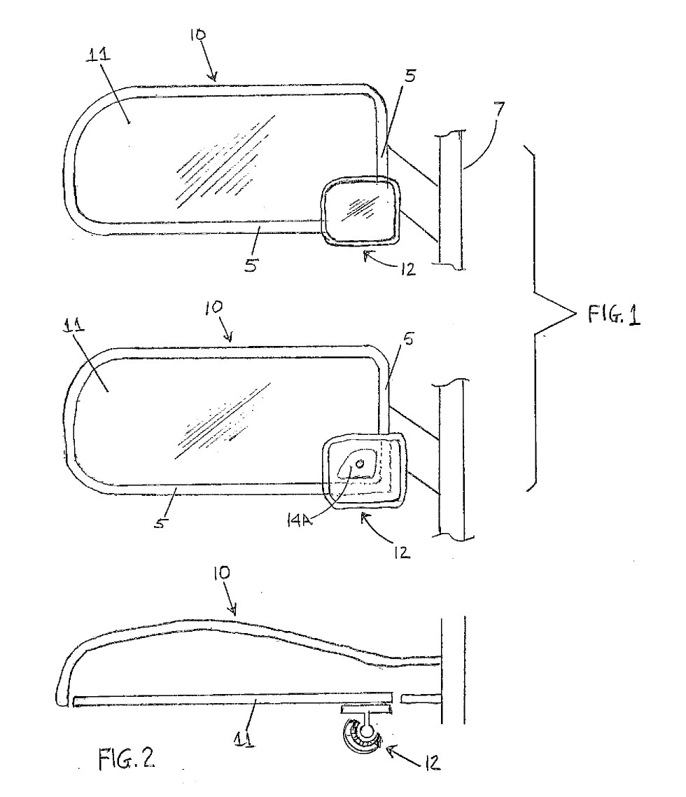

FIG. 2 is a cross-sectional view of the mirror of FIG. 1 showing the adjustable blind-spot mirror of the present invention attached to a standard driver side mirror of a vehicle.

In FIGS. 1-5 a rear view mirror device is an adjustable rear view blind-spot mirror assembly 12, also termed herein and claimed as a utility mirror, for pinpointing precise viewing location behind a user, and comprises a rear view mirror 12 pivotally mounted on a base 14A.

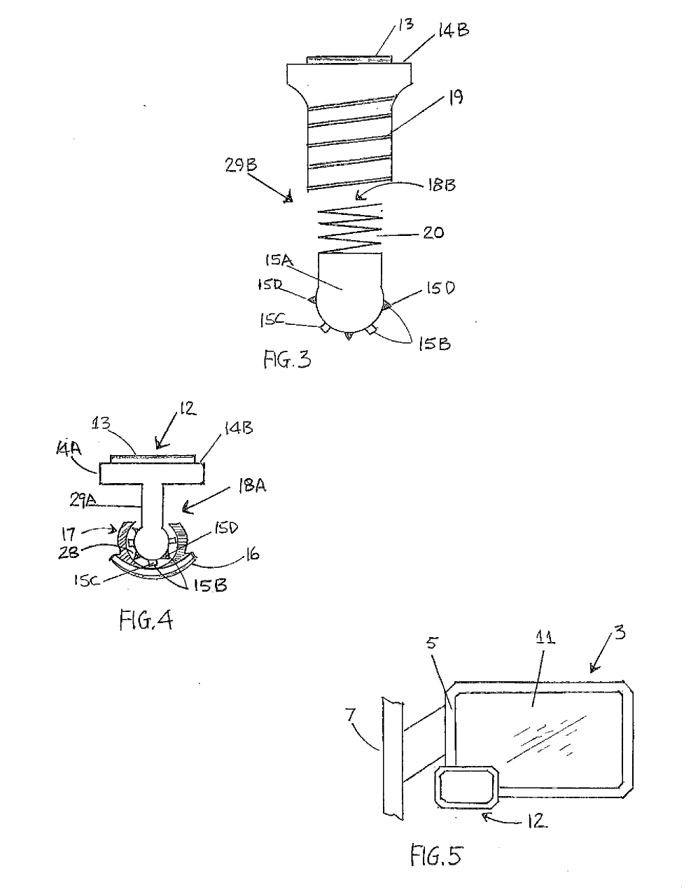

The blind-spot mirror assembly 16 as shown in FIG. 4 comprises a base 14A, which is smaller than the mirror 16 in size, a fixed post 29A, or an adjustable post 29B as shown in FIG. 3, a flat exterior attaching surface 14B covered with an adhesive layer 13, which may have a peel-off covering removable for mounting, an interior mounting surface 28, a ball assembly 18A and a socket assembly 17 forming a pivotal connection attaching the mirror 16 to base 14A. From FIG. 2 and other figures incorporated in the present application it will be apparent to the skilled person that the ball and socket assembly shown is an example of a limited universal pivot mechanism, meaning that the utility mirror may be angled in any direction away from a plane parallel with the base to which the adhesive layer attaches, but limited in amount of deviation by the nature of and dimensions of the mechanism.

FIG. 3 shows an adjustable post assembly 29B comprising ball assembly 18B with a plethora of squares and pointed tops 15B and an inner threaded insert 20, which if screwed in to outer threaded insert 19, will result in lowering of the ball 15A and by unscrewing the ball will result in raising the ball assembly 18B. The mating of the ball assembly 18B and socket assembly 17 provides adjustability of the mirror 16 to move up and down as adjustment may be needed to accommodate the valiance of distances between the side mirror glass 11 and side mirror edge 5 which varies from vehicle to vehicle.

Mirror 16 comprises a narrow-focus mirror, which can be made flat, convex and/or rectangular or a combination thereof, wherein the mirror is not greater than three inches in width, and having movable connection enabling reflective viewing of a specific location. The mirror 16 which is a part of socket assembly 17 is pivotally attached to ball 15A and socket 17, and the post 29A or post 29B are at an angle to the exterior attaching surface 14B to pick up reflections of specific locations such as the driver's “blind spot” not visible in the driver side mirror 10 or passenger side mirror 3 as shown in FIG. 5, because of the different angle on a side mirror mount as shown in FIGS. 1-2,5, and such as an entryway to a room or a cubicle not visible behind a user of a computer monitor or computer laptop mount, shown in FIGS. 32-49 and 54-57. The ball and socket connection allows for a full circular range of motion to be adjustable at any desired angle to focus on a precise viewing location.

In FIG. 4 the ball and socket connection preferably comprises the mating of a plethora of squares and pointed tops 15B with interior mounting surface 28 of the socket assembly 17 that will form an automatic easy-to-use locking of the mirror 16 which may be implemented as a convex, a flat or a combination of flat at the middle and curved or convex at left and right ends, and can be made of variety of materials such as plastic or glass at any desired angle one or more of the squares and/or pointed tops engaging with interior mounting surface 18.

In FIGS. 1-2, 5, the blind-spot mirror 12 is adapted for mounting on the flat reflective surface 11 of a side mirror 10 of a vehicle 7 adjacent to an edge thereof, which is preferably the inside edge on the driver's side mirror, as shown in FIGS. 1-2, in a preferred lower corner, as shown in FIG. 1. On a passenger side mirror, shown in FIG. 5, the blind-spot mirror may be attached to the lower left corner. The base 14A is adapted to adhere to the reflective surface 11 of the side mirror 10 with the mirror surface 16 of the device extending over the edge of a side mirror for the least interference with viewing through the side mirror 10.

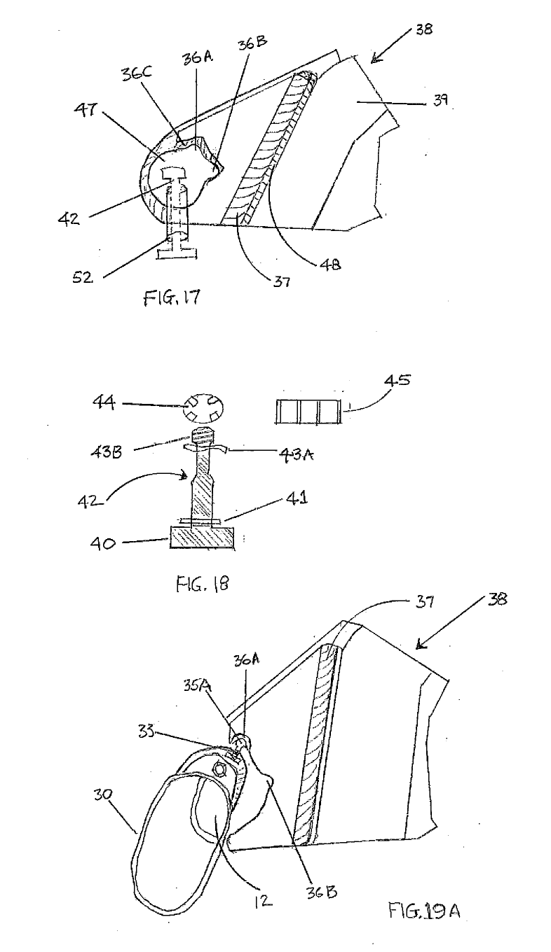

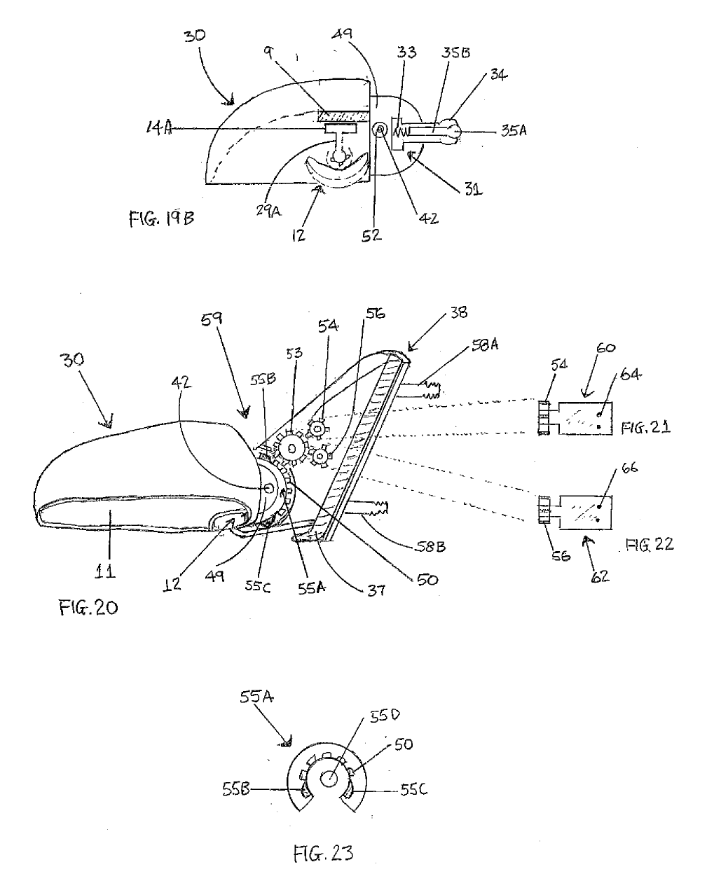

FIG. 9 is an illustration of a rear view blind-spot mirror assembly 21B which comprises a mirror 16, a horizontal socket 23 for horizontal installation, a vertical socket 24 for vertical installation and a base assembly 18C as shown in FIG. 12, which comprises a ball 15A, ball protrusions 15B, an oval frontage 26, an adhesive layer 13, an attaching surface 14B as shown in FIG. 10, and/or an attachment surface 14C shown in FIG. 11, which may be attached to a rear view mirror 21A by either attaching the mirror to a placement 22A or placement 22B or any other area that is suitable for the driver that is in the frontal portion of the rear view mirror 11, as shown in FIG. 13.

One of the installation options may be when ball 15A of base 18C as shown in FIG. 12, using attaching surface 14-B as shown in FIG. 10, forms a pivotable connection with horizontal socket 23 creates an assembly that shows a parallelogram between back plate 25A and base 18C as shown in FIG. 8, with a preferred placement for this configuration is placement 22B where attaching surface 14B is adapted for mounting on the flat reflective surface 11 as shown in FIG. 13.

Another pivotable connection option is between ball 15A of base 18C using attaching surface 14C as shown in FIG. 11, and vertical socket 24 forms a perpendicular relationship between back plate 25A and base 118C as shown in FIG. 9, with placement 22A as the preferred configuration where attaching surface 14C, which has a curvature in order to have a solid adhesion to mirror shoulder 8 which may or may not have its own curvature, because this will provide the driver the least interference with the viewing through the vehicle's rear view mirror 21-A.

In addition, base 18C includes an oval frontage 26 to accommodate clearance for the back plate bottom edge 25B movement from left to right without obstruction when back plate 25A is at most bottom angled position. Either placements 22A or 22B may be able to provide the driver the ability to maneuver the mirror 16 on a full circular range of motion to be adjustable at any desired angle to focus on all the “blind spots” at one glance that is the driver and the passenger blind spots not seen on vehicles driver side nor passenger side mirrors.

FIG. 14 is another illustration comprising a blind-spot mirror 12 being integrated into the main mirror of vehicle's side mirror 10. In this embodiment there is a cut-out on mirror or flat surface 11, the purpose of which is the insertion of mirror 12. The mirror assembly 12, as shown in FIG. 4, comprises a base 14A which may be attached into the front of side mirror back plate 4. One of the ways would be to permanently glue the base 14A into back plate 4 or any other configurable way so it may be able to implement the independent movement of mirror 16 off mirror 10 by way of ball 15A and socket assembly 17 as shown in FIGS. 1 and 2, ending into one side mirror assembly 30.

One other embodiment that is shown in FIG. 14, is the ability of the driver to be able to fold the mirror assembly 30 when needed towards the door glass 39 especially if parking in tight spaces or when the vehicle is going to be washed at automatic car washes. In this embodiment there is mirror assembly 30 that is mated via guide plate 49 through a connector bolt 42 that passes through bracket cavity 52 as shown FIGS. 17 and 25, and connects with bracket assembly 38 as shown in FIG. 17, via connector bolt 42, through bracket cavity 52 and loosely tighten by a wave washer 43A and finally tightened by either push nut washer 44 or threaded nut 45.

In use the driver pulls mirror 30 towards the vehicle's door glass window 39 which in effect pushes the spring 33 by ball shaft 35B which at present time the ball 35A is at lock position against locker seat 36B, the thrust created by pulling mirror 30 forces the ball 35A out of locker seat 36B into locker seat 36A thereby transforming the mirror 30 in a folded position as shown in FIG. 19A. To revert back the mirror 30 into driving position, the reverse is applied, whereby the driver pushes mirror 30 forward, thus ball 35A is forced out of lock position with locker seat 36-A by the ball 35A pushing the spring 33 by ball shaft 35B into locker seat 36-B.

FIG. 15 is an illustration of a locker assembly 31 comprising a locker base 32, the purpose of which is to hold locker 31 and be permanently affixed either by gluing or screwing into guide plate 49, a spring 33 whose purpose is to push the ball 35A via shaft 35B and a stopper 34 whose function is hold the ball 35-A in a locked position. The mating of spring 33 and locker shaft 35B may be implemented in many other ways as one would be the spring 33 just presses against shaft 35B or another way would be the spring 33 is screwed into the end of shaft 35B.

FIG. 16 is an illustration of a deflector plate 37 comprising contour 27, a purpose of which is to create a vacuum on door glass 39 as shown in FIG. 14, a support 48 whose function is to hold the contour 27 in place during high speed of vehicle. When the vehicle is in motion, the wind 46 passing through the door glass 39 will be deflected via contour 27 thus creating a vacuum effect against door glass 39 which will be useful when a vehicle is driven on any rainy days. The vacuum effect created while the vehicle is in motion will keep the glass 39 adjacent to or around the vicinity of support 48 dry, because the vacuum effect will suck out any rain droplets that might otherwise stick into the glass 39.

FIG. 17 is an illustration of a bracket assembly 38, comprising receptor plate 47, the purpose of which is for the guide plate 49 as shown in FIG. 19B, to be able to rotate forward and backward mirror 30 as held together by connector bolt 42, thru bracket cavity 52, a locker seat 36A which purpose is to hold in place locker ball 35A the mirror 30 in a folded position, a locker seat 36B whose purpose is to hold in place locker ball 35A the mirror 30 in normal or driving position, an indentation 36C whose purpose is to guide locker ball 35A movement between locker seat 36A the parking position of mirror 30 and locker seat 36B the driving position of mirror 30 and a deflector plate 37 the purpose of which is to vacuum rain drops off door glass 39 while the car is in motion that might have otherwise attach to such door glass and by deflection of air off of deflector plate a vacuum effect is created.

FIG. 18 is an illustration of a connector bolt assembly 42 the purpose of which is to hold mirror assembly 30 and bracket assembly 38 together, comprising a base 40, flat washer 41, whose function is to make it easy for the rotation of mirror 30, a wave washer 43A whose purpose is make the mirror 30 and bracket 38 snug fit but rotatable, a push nut washer 44 for locking the bolt assembly 42 as one of the options, and a nut locker 45 that screws in with end screw 43B as the other option of locking bolt assembly 42.

FIG. 19A is an illustration showing mirror 30 in parking position where locker ball 35A is pressed against locker seat 36A by spring 33.

FIG. 19B is showing the top view mirror 30 that comprises guide plate 49 the purpose of which is to hold locker assembly 31, a bracket cavity 52 in which bolt 42 passes through for attachment of bracket 38 as shown in FIG. 17, a bracket 9 a component of side mirror 30 one purpose of which is hold base 14A of blind-spot mirror 12 in place.

FIG. 20 is another illustration of blind-spot mirror 12 being integrated into the main mirror 10 as shown in FIG. 2, in which mirror 30 can be folded forward or backward via an electronically-controlled switching mechanism as shown in FIG. 29. In this embodiment there is a connector bolt 42 as shown in FIG. 18 that is positioned inside the cavity 52 as shown in FIG. 25, the purpose of which is to make a pivotable connection of mirror assembly 30 that is attached to locking gear plate 55A as shown in FIGS. 23, 26-27, and bracket assembly 38 in a rotatable manner in which mirror 30 can be rotated forward and backward while it is seated at opening plate 68 of bracket 38, having bracket bolts 58A and 58B as shown in FIG. 25. The movement of mirror 30 is propelled by two electric motors 60 and 62 which are reversible and could either be a DC or AC motor through each respective wiring connections 64 and 66 as shown in FIGS. 21-22, which by means of spur gears 54 or any other type of gears, in-tandem attached at the end of each motor's shaft that engages with reduction spur gear 53 or any type of reduction gear then drives with enough torque the locking gear plate 55A, the attached mirror 30 either forward or backward depending upon which switch selection the driver has chosen.

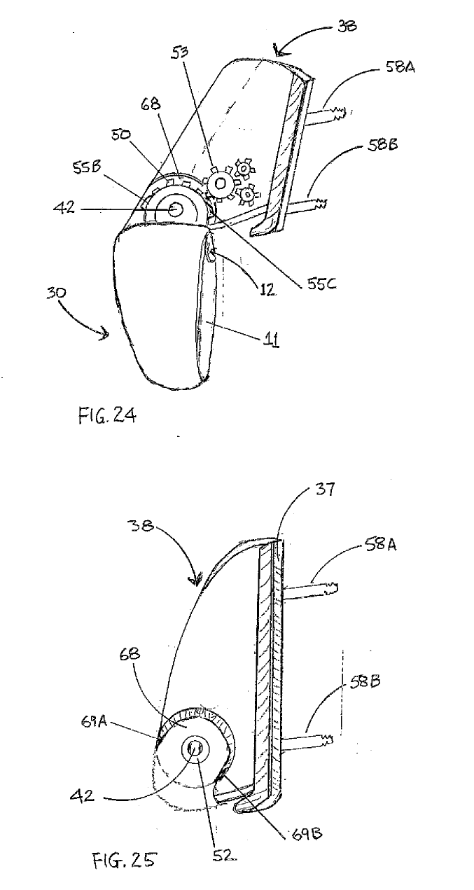

FIG. 23 is an illustration of a structure showing a stopping mechanism that comprises evenly spaced mirror gears 50, the purpose of which is to move mirror 30 forward or backward, a front end locking gear tooth 55B which has a rounded gear tooth at one end towards the center of locking gear plate 55A, the purpose of which is to block and stop the reduction gear tooth 53 on its continuous rotation thereby stopping the movement of mirror 30 in driving position, as shown in FIG. 20, and back end locking gear tooth/electric contact 55C, that comprises a rounded gear tooth at one end towards the center of locking gear plate 55A, that holds the mirror 30 at its park position as shown in FIG. 24.

FIG. 24 shows the mirror 30 in electronically folded position, in which the reduction gear tooth 53 becomes locked into position against back end locking gear tooth/electric contact 55C. FIG. 25 shows the bracket assembly 38 comprising bracket bolts 58A and 58B, the purpose of which is to attach the bracket into the doors of the vehicle's driver and corresponding passenger doors, a glass wind deflector 37 the purpose of which is to vacuum out rain drops attaching unto glass of vehicle door, a bracket cavity 52 in which the connect bolt 42 seats, a receptor plate 68 in which locker gear plate 55A is bolted on as shown in FIG. 23, and pivotally attached to mirror 30 forms a final mirror assembly 59 as shown in FIG. 20.

FIG. 26 shows the layout of side mirror 30, comprising a blind-spot mirror 12, which could be adjusted manually as shown in FIG. 14, and electronically adjusted as shown in FIG. 20, a locking gear plate 55A, one purpose of which is for the mirror 30 to be folded either manually as shown in FIGS. 14 and 19A, or could be folded electronically as shown in FIGS. 20 and 24, a plate cavity 51 the purpose of which is for the connector bolt 42 to pass through, for a pivotable connection of mirror 30 and bracket 38, gears 50 the purpose of which is to move mirror 30, a front end locking gear 55B whose purpose is to lock mirror 30 into driving position as shown in FIG. 20, and back end locking gear/electric contact 55C whose purpose is to lock mirror 30 into parking position as shown in FIG. 24.

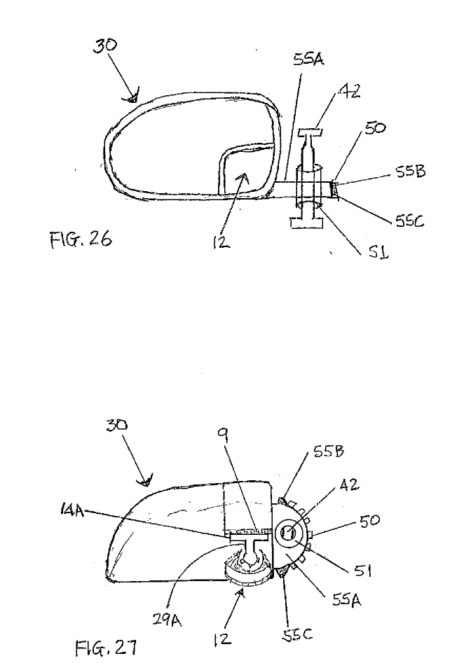

FIG. 27 is the top view of mirror 30 that comprises locking gear plate 55A, the purpose of which is to move the mirror 30 either forward into driving position as shown in FIG. 20 and backward into parking position as shown in FIG. 24, a plate cavity 51 in which connection bolt 42 passes through for a pivotable connection of mirror 30 and bracket 38, gears 50 whose purpose is move mirror 30 forward and backward, a bracket 9 whose function is to hold blind-spot mirror base 14A and front end locking gear 55B and back end locking gear/electric contact.

In operation, when gears 54 and 56 in-tandem engage with reduction gear 53 shown in FIG. 20, then forces gears 50 of the locking gear plate 55A to rotate until the gear tooth of reduction gear 53 locks with the top of the front end locking gear tooth 55B because it is positioned a lot closer to the adjacent gear tooth 50 and thereby not allowing reduction gear tooth 53 to engage between two of evenly spaced gears teeth 50 but by resting on top of front end locking gear 55B resulting in termination of locking gear plate 55A movement resulting in mirror 30 moving into driving position as shown in FIG. 20. When the driver parks the car and decided to fold the mirror into its park position the reverse operation occurs. The motors 60 and 62 in tandem now run on reverse rotation as the signal sent to motors has been sent from manual/auto switch 114 as shown in FIG. 29. The gears 54 and 56 in-tandem engages with the reduction gear 53 as shown in FIG. 20, forces gears 50 of the locking gear plate 55A to rotate until the gear tooth of reduction gear 53 locks with the top of the back end locking gear tooth/electric contact 55C because it is positioned a lot closer to the adjacent gear tooth 50 and thereby not allowing reduction gear tooth 53 to engage between two of evenly spaced gears teeth 50 but by resting on top of front end locking gear/electric contact 55C resulting in termination of locking gear plate 55A movement resulting mirror 30 into parking position as shown in FIG. 24. The gears 53, 54 and 56 may be of any one of a broad variety of materials, such as plastic, metal or any other rigid material.

In use, the driver will have the ability to fold the mirror forward (drive) and backward (park) positions by activating the switching mechanism from the inside of the vehicle as shown in FIG. 29. The driver has the option to activate the folding of mirror 30 either manually by pressing switch 114 or automatically by pressing switch 110. When the driver opts for the automatic option by pressing switch 110, motors 60 and 62 will position mirror 30 into driving position automatically, that is activated by same switch that started the car's engine. The current that supplies the motors will be cut-off once it senses that gears 53 hits front end locking gear 55B. When driver turns-off the engine, a sensor is activated to send electrical current to motors 60 and 62 on a reverse rotation until gears 50 is stopped by back end gear/electric contact 55C and electric signal is then cut off.

When the driver opts to press manual switch 114, the purpose of which is to activate either drive switch 116, whose function is to rotate mirror 30 into drive position as shown in FIG. 20, and park switch 112 whose function is to rotate mirror 30 into park position as shown in FIG. 24. The current supplying motors 60 and 62 are both cut-off once gears 50 either hit front end locking gear 55B or back end locking gear/electric contact 55C.

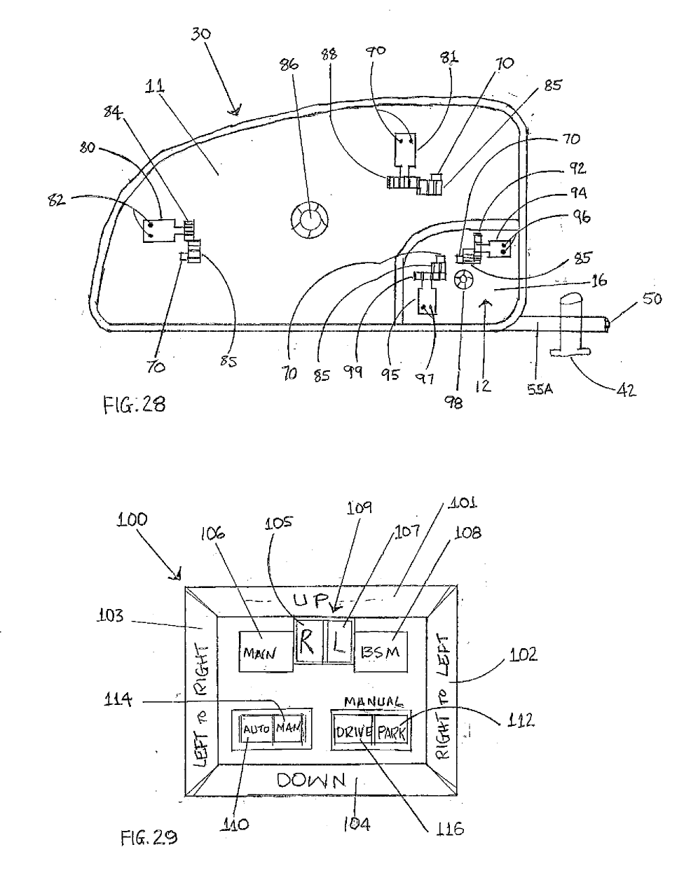

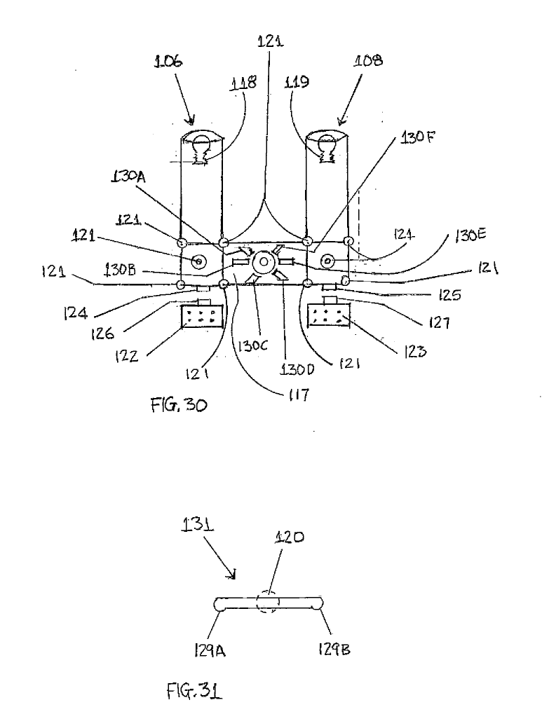

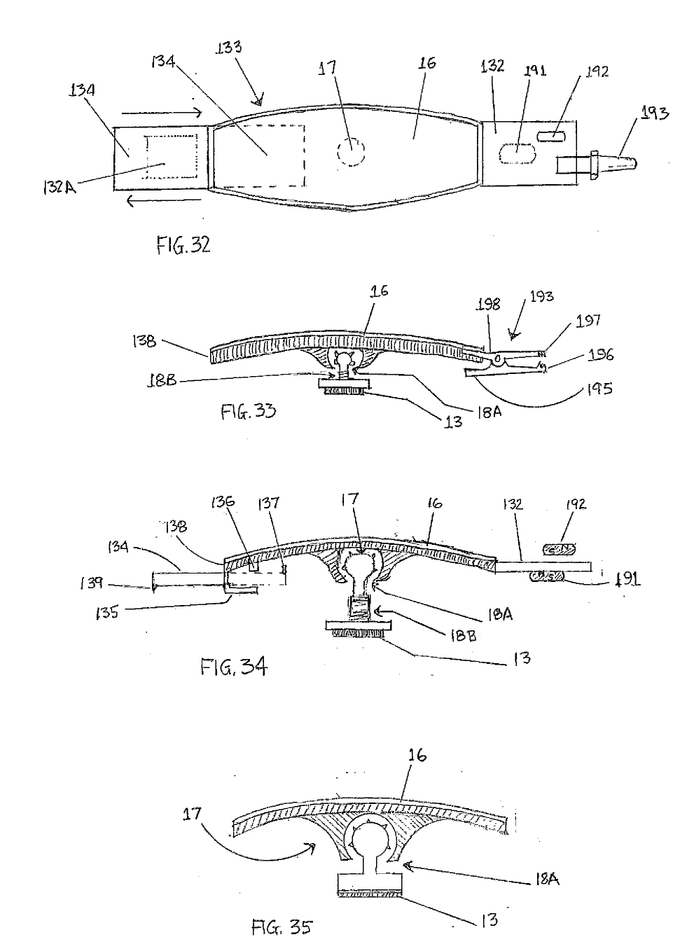

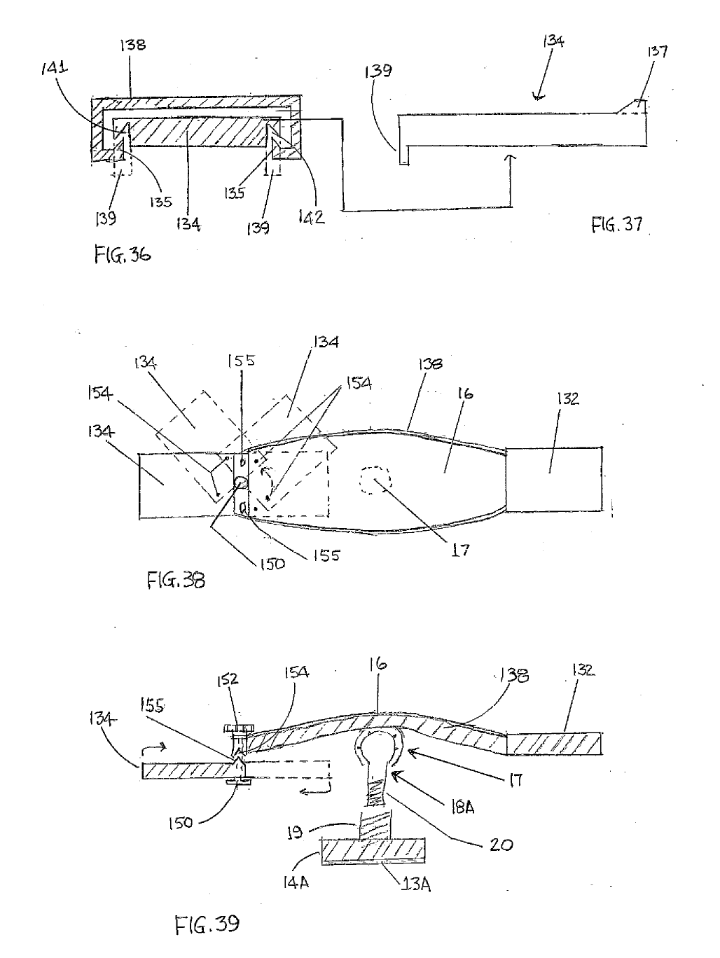

FIG. 28 is an illustration showing the a prospective layout as to how side mirror glass 11 of side mirror assembly 30 and mirror 16 of blind-spot mirror assembly 12 will be moved independently of one another depending upon the needs of the driver of the vehicle as controls are shown in FIG. 29, comprising a motor 80 whose function is to move the mirror 11 side to side via motor gear 84 that attaches to reduction gear 85 through post 70, a motor 81 whose function is to move mirror 11 up or down via motor gear 88 that attaches to reduction gear 85 through post 70, a ball and socket 86 whose purpose is to hold mirror glass 11 so it can be moved on a 360 degree rotation, a motor 95 whose function is to move the blind spot side mirror 16 side to side via motor gear 99 that attaches to reduction gear 85 through post 70, a motor 94 whose function is to move blind-spot mirror 16 up or down via motor gear 92 that attaches to reduction gear 85 through post 70. Motors 80, 81, 94 and 95 may be reversible motors, which could be either of a DC or AC type. Motor gears 84, 88, 92 and 99 may be of any one of a broad variety of materials, such as plastic, metal or any other rigid material, and ball and socket 98 that holds mirror assembly 12. This configuration applies to both driver side mirror 10 as shown in FIG. 1 and passenger side mirror 3 as shown in FIG. 5.

FIG. 29 is an illustration of master switch 100 whose purpose is to provide the driver from the inside a vehicle the ability to electronically control the movements of not only both driver and passenger regular side mirrors (light or left), both of driver and passenger blind-spot mirrors (right or left) as shown in FIGS. 1 and 5, but also controls the folding of mirrors manually or automatically, comprising a main mirror switch 106 whose function is to control the movement of both side mirrors by activating right switch 105 and left switch 107, and then activates up-switch 101, right-to-left switch 102, left to-right-switch 103 and down switch 104, a blind-spot mirror switch 108 the purpose of which is to control the movement of blind mirrors remotely via up switch 101, right-to-left switch 102, left-to-right switch 103, and down switch 104. Switches for folding of mirrors 10 as shown in FIGS. 1 and 2, and mirror 3 as shown in FIG. 5, comprise auto switch 110, the purpose of which is for the driver and passenger mirrors to fold automatically into driving position if ignition is on as shown in FIG. 20, and at park position if ignition is off, as shown in FIG. 24, a manual switch 114 the purpose of which if activated provides the driver to manually control the folding of mirrors 10 and 3 by either activating drive switch 116 or park switch 112.

FIG. 30 is an illustration of a switching mechanism as shown in FIG. 29, comprising a main switch mirror 106, a led light 118 whose purpose is to let driver know that this switch is on, a blind-spot mirror switch 108, a led light 119 whose purpose is to indicate that switch 108 is on, various bolt joints 121 whose purpose is to provide the flexible movement for activating switching mechanism between main mirror switch 106 and blind-spot mirror switch 108, magnets 124 and 125 whose function is to attach to flat steel 126 and 127 and activate electrical current for switches 106 and 108, various electrical connectors 122 and 123 whose purposes are to make electrical connections as required by switches that has been turned on or off, a bolt joint 128 whose purpose is to hold locking bar 131 whose protrusions 129A and 129B locks into place with the indents 130A thru 130F of switch plate 117 into three different settings.

FIG. 31 is an illustration of a locking bar 131 comprising a cavity 120 whose purpose is for the bolt joint 128 to pass through and be held by it and protrusions 129A and 129B the purpose of which is to lock into indents 130 for three positions, namely neutral, turning main switch 106 on and turning blind-spot mirror 108 on.

In use when indents 130B and 130E lock into protrusions 129A and 129B this creates a neutral position or off position because magnets 124 and 125 are not making contacts with flat steel 126 and 127 and neither led lights 118 nor 119 are lit, but when indents 130A and 130D lock into protrusions 129A and 129B by pressing main mirror switch 106 creates an on position for main mirror switch because magnet 124 and flat steel 126 are now engaged thereby electrical current are flowing which turns on led light 118, activates switches 109 and 107 that turns on switches 101, 102, 103 and 104 respectively, and when indents 130C and 130F lock into protrusions 129A and 129B by pressing blind-spot mirror switch 108 creates an on position for blind-spot mirror switch because magnet 125 and flat steel 127 are now engaged thereby electrical current are flowing which turns on led light 119, activates switches 109 and 107 that turns on switches 101,102, 103 and 104 respectively.

FIG. 32 is a top view illustration of a computer mirror 133 comprising a movable frame 134 the purpose of which is for the user to be able to attach a variety of favorite photographs or notes, a socket assembly 17 which has the purpose of being able to rotate mirror 16 on a 360 degrees movement and a fixed frame 132 which may be implemented either as a fixed frame where photographs or notes may be attached or flat mirror for personal grooming. Attachment of this mirror to a computer monitor is shown in FIGS. 40, 44-46, 54-57.

FIG. 33 is an illustration of a mirror 16 which may be implemented where the middle portion of the mirror is straight and it curves at both ends the purpose of which is to have a better clarity of the images at the middle part of the mirror but still gets wider coverage by means of both angled mirror ends, a choice of ball assemblies between a fixed 18A as shown in FIG. 4, or an adjustable 18B as shown in FIG. 3, and an adhesive layer 13 the purpose of which is to attach this mirror to any top or sides of a computer monitor.

FIG. 34 is a side view illustration of a computer mirror 133 showing the mechanism as to how frame 134 may be implemented comprising a lower guide 135, an upper guide 136 the purpose of which is to guide frame 134 to be pushed in and out, a bottom stopper 139 whose function is stop the frame from not going in any further when it hits lower guide edge 135, a top stopper 137 whose function is to stop the frame from going out when it hits the upper guide 136, a socket assembly 17 and a fix ball assembly 18A or an adjustable ball assembly 18B and an adhesive layer 13. FIG. 35 is an illustration showing how this computer mirror 133 may be implemented in which frame 134 and frame 132 may not be used.

FIG. 36 is an illustration showing a front view of the mechanism showing how frame 134 movement in and out works, comprising support 138, a lower guide 135 the purpose of which is to carry and hold movable frame 134 comprising a left frame cavity 141 and a right frame cavity 142 that rides and glides over lower guides 135. FIG. 37 is an illustration of a movable frame 134 comprising a bottom stopper 139 the purpose is to stop the frame for not going in any further when it hits lower guides 135 and top stopper 137.

In use the user has the option of pulling frame 134 out of its parked position by grabbing the bottom stopper 139 and continue to pull out while riding on lower guides 135 and eventually will be stopped when top stoppers 137 hits upper guide 136 as shown in FIG. 34.

FIG. 38 is an illustration of a top view of one other way in which frame 134 may be implemented comprising a mirror 16, a socket assembly 17, a fixed frame or flat mirror 132, a bolt 150 whose purpose is to hold the frame edge into the edge of mirror support 138 having a pair of protrusions 155 as shown in FIG. 39, the purpose of which is to lock into a pair of indents 154 located at the edge of frame 134 at every 180 degrees rotation.

FIG. 39 is a side view of FIG. 38 comprising a mirror 16, a support 138, a fixed frame or flat mirror 132, a bolt 150 and nut 152, a pair of indents 154, a pair of protrusions 155, a socket assembly 17, a ball assembly 18A which can be implemented by having fixed post as shown in FIG. 4, an adjustable post as shown in FIG. 3 or some other type of post may be implemented, a base 14A and an adhesive layer 13 which could then be attached to any edge of a computer monitor or other similar instruments as shown in FIG. 46.

In use the user will have the option of using another frame for pictures or note attachment in addition to an existing fixed frame or flat mirror 132. To activate the use of frame 134, the user rotates the frame into 180 degrees rotation until the frame's pair of indents 154 locks into a pair of protrusions 155 located at the edge of mirror support 138.

FIG. 40 is an illustration of another way in which computer mirror 133 may be implemented by way of incorporating the computer mirror inside of any edges of a laptop computer 160. In this embodiment there is the front laptop case 167, where the computer mirror may be inserted at various front locations of the laptop computer or any other similar instrument. For example, computer mirror 133 may be installed at the right top corner of the laptop alone, or computer mirror 133 may be installed at the left top corner alone and on its own, or both mirrors 133 and 133 may be installed together at their respective corner locations, the mirror may be installed at side edges where mirror 133 and 133 sits.

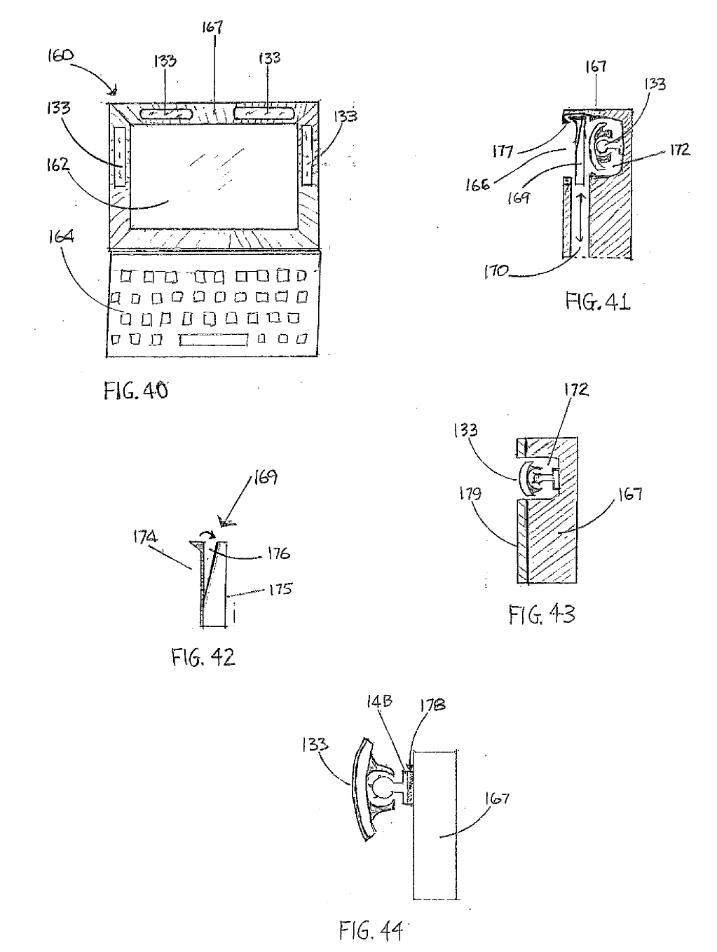

FIG. 41 is an illustration of an installation of computer mirror 133 at the top edge or side edges of the laptop case 167 as shown in FIG. 40. In this embodiment there is a mirror cavity 172 which may be vertically on the side edge or horizontally positioned at the top edge of laptop case the purpose is to house and hold the computer mirror and give a full 360 degree mobility to its mirror 16 without any obstruction, a mirror guard cavity 170 the purpose is let mirror guard 169 to slide in or out over the top of mirror 133 when not is use and for its protection. FIG. 42 is the illustration of a mirror guard 169 comprising a base 175 whose purpose to glide over cavity 170, a cavity 176 the purpose is to let locking bar 174 have room to expand if pressed for locking and unlocking into the locking tip 177.

FIG. 43 is an illustration of one other embodiment in which computer mirror 133 is inserted into the edge of a laptop computer or any other similar instruments comprising a cavity 172 which may be embedded vertically on the side edge or horizontally positioned into the top edge of laptop case 167 the purpose is to house and hold computer mirror 133 without obstruction for its mirror 16 and be able to rotate 360 degrees without interference. In this embodiment the mirror is placed just a bit lower than the front edge 179 so you may be able to close the laptop snugly and may not require a mirror guard for its protection.

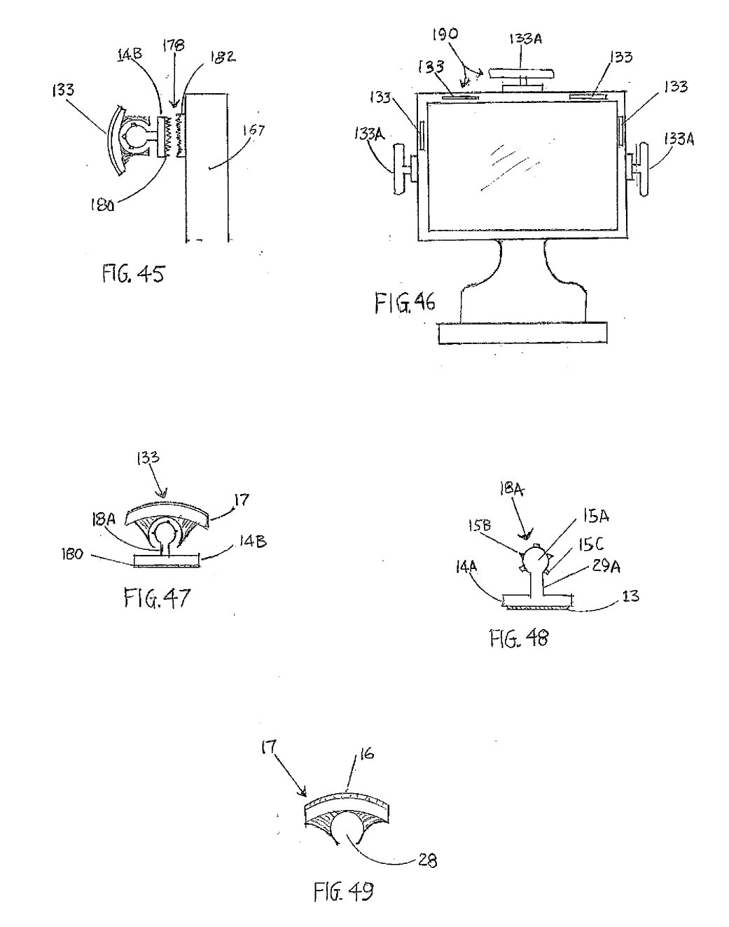

FIG. 44 is a top view illustration of one other way in which computer mirror 133 may be implemented into an existing laptop, comprising an attaching surface 14B the purpose is to attach and hold the velcro 178. FIG. 45 shows the exploded view of the embodiment of Velcro™ 178 comprising a male Velcro™ 180 that may be attached to attaching surface 14B of mirror 133, a female Velcro™ 182 that may be attached to the front edge of laptop case 167 one purpose of which is to hold mirror assembly 133 through attachment to Velcro™ 178 when the computer is in use.

In use the user opens up the laptop and attaches the male Velcro™ 180 that attaches the computer mirror assembly 133 as shown in FIG. 47, over female Velcro™ 182 and adjust the mirror to the desired rear view viewing as shown in FIG. 40. When the user is done using the laptop, the user pulls the computer mirror for safe keeping by separating Velcro™ 180 off Velcro™ 182 then closes and locks the computer without any interference from Velcro™ 182.

FIG. 48 is an illustration of ball assembly 18A which may be fashioned in using a fix post 29A or an adjustable post 18B as shown in FIG. 3. FIG. 49 is an illustration of a socket assembly 17 that may adopted either to using a fixed post 29A or an adjustable post 18B.

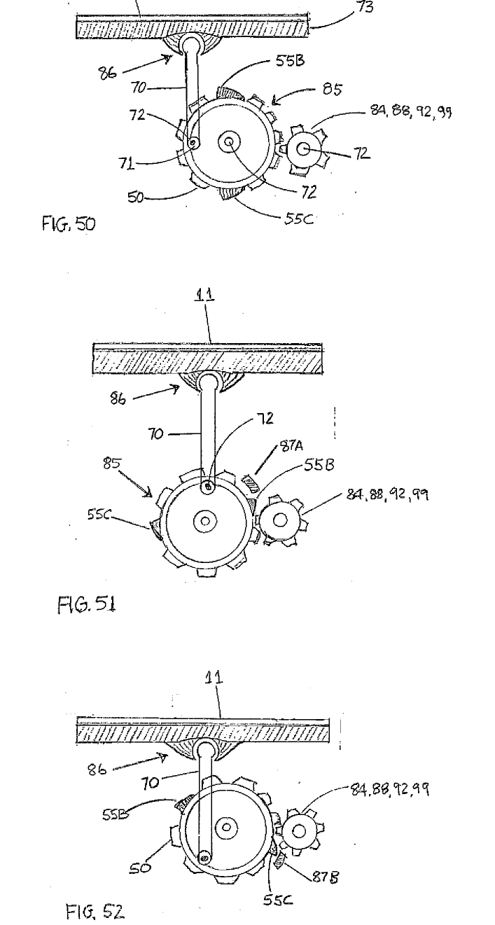

FIG. 50 is an illustration of a mechanism that controls movement of mirror 11 and blind-spot mirror 16 electronically as shown in FIG. 28, from controls from the inside of the vehicle as shown in FIG. 29. In this embodiment there is a side mirror 11, a bracket 73 that supports the mirror, a ball and socket 86 whose purpose is to be able to rotate mirror 11 to 360 degrees rotation, a post 70 that is attached to a ball and socket and attached to gear cavity 71 of reduction gear 85 the purpose of which is to move the mirror 11 up or down or left or right. The reduction gear 85 comprising, a front-end locking gear 55B and back-end locking gear/electric, contact 55C whose purpose is to control travel of mirror 11 through post 70 up or down, left or right, gears 50 and the coupling and shaft assembly 72 which engages with the motor gears 84, 88, 92 and 99.

In use when the driver activates by pressing side mirror switch 106 switches 109 and 107 are also activated. When side mirror switch 106 is on, pressing right mirror switch 105 activates switches 101,102,103 and 104 which are up, right to left, left to right and down respectively and by pressing left mirror switch 107 activates switches 101, 102, 103 and 104. Pressing blind spot switch 108 also activates switches 109 and 107. When side mirror switch 108 is on, pressing the right mirror switch 105 activates switches 101,102,103 and 104 which are up, right to left, left to right and down respectively and pressing left main mirror switch 107 activates switches 101,102,103 and 104. For example when switch 106 is on and switch 109 is on and by pressing switch 101 to on then motor 81 shaft gear 88 turns counterclockwise which in turn rotates reduction gear 85 clockwise moving shaft 70 towards up position lifting mirror 11 up as it adjust its position via ball socket 86 until the front end locking gear 55B engages with one of the gears of motor gear 84 or the driver releases switch 101 then the movement stops as shown in FIG. 51. On the other hand, when switch 106 is on and switch 109 is on and by pressing switch 104 to on then motor 81 shaft gear 88 turns clockwise which in turn rotates reduction gear 85 counterclockwise moving shaft 70 towards down position lowering mirror 11 down as it adjust its position via ball socket 86 until the front end locking gear/electric contact 55C engages with one of the gears of motor gear 84 or the driver releases switch 104 then the movement stops as shown in FIG. 52. The adjustments for the blind-spot mirror 16 is the same as shown above, except it uses different motors 94 and 95.

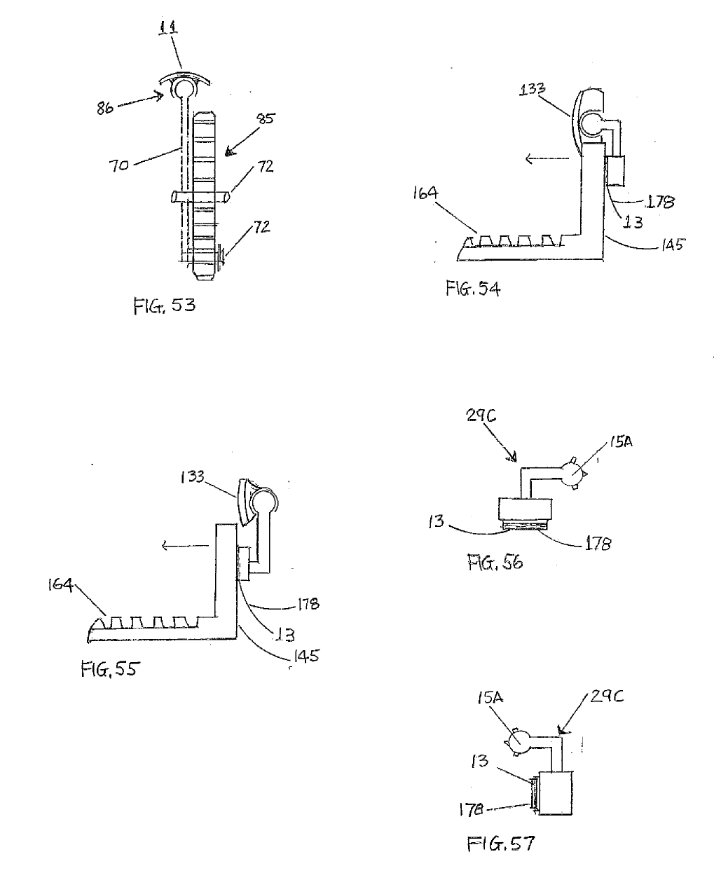

Side mirror motors are 80 and 81 respectively. FIG. 53 is the side view reduction gear 85 comprising a ball and socket 86, a post 70, coupling and shaft assembly 71 and mirror 11.

FIG. 54 is another illustration that computer mirror 133 may be implemented. In this embodiment there is a L post 29C whose purpose is to be able to be attached at the back of a laptop or any other similar instruments, a computer back 145, an adhesive layer 13 or Velcro™ 178 which will provide the user the flexibility of detaching the mirror assembly for safe keeping if the laptop is not in use, a ball 15A and keyboard 164. The attachment for a computer mirror 133A while attaching it at top or sides of a computer monitor 190 is shown in FIG. 46. FIGS. 56 and 57 are the illustrations of a L post 29C which may be opted as others ways in which computer mirror 133 may be implemented. FIG. 9 is another illustration in which computer mirror 133A may be implemented on top of a computer monitor 190 or on top of a laptop case.

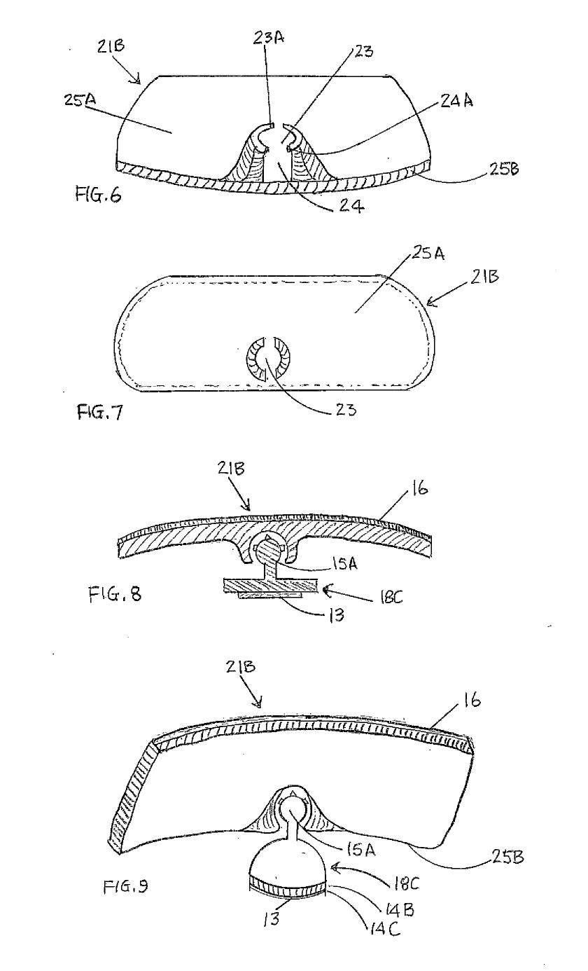

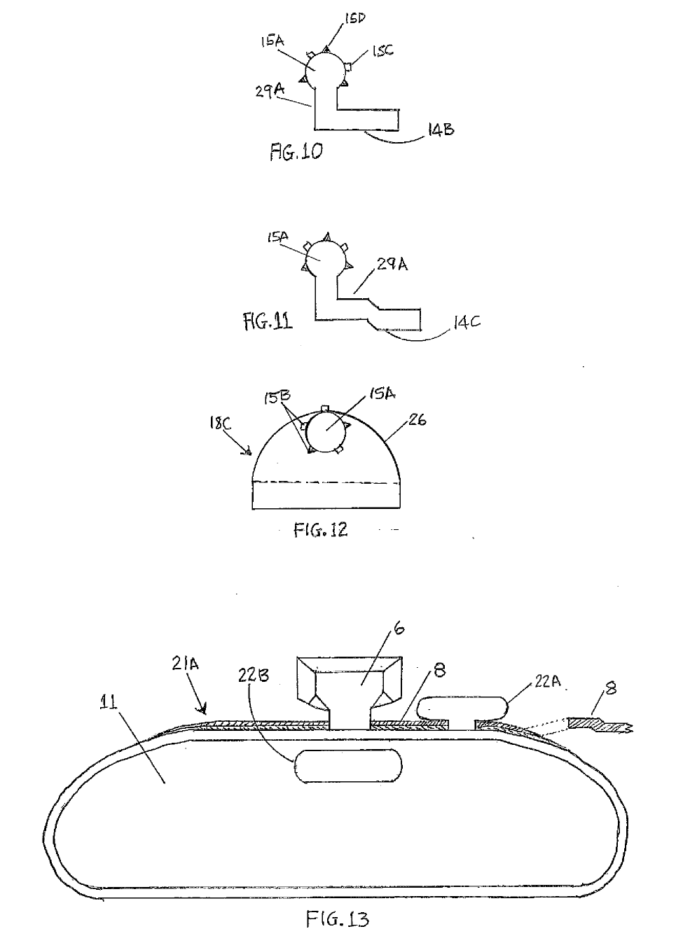

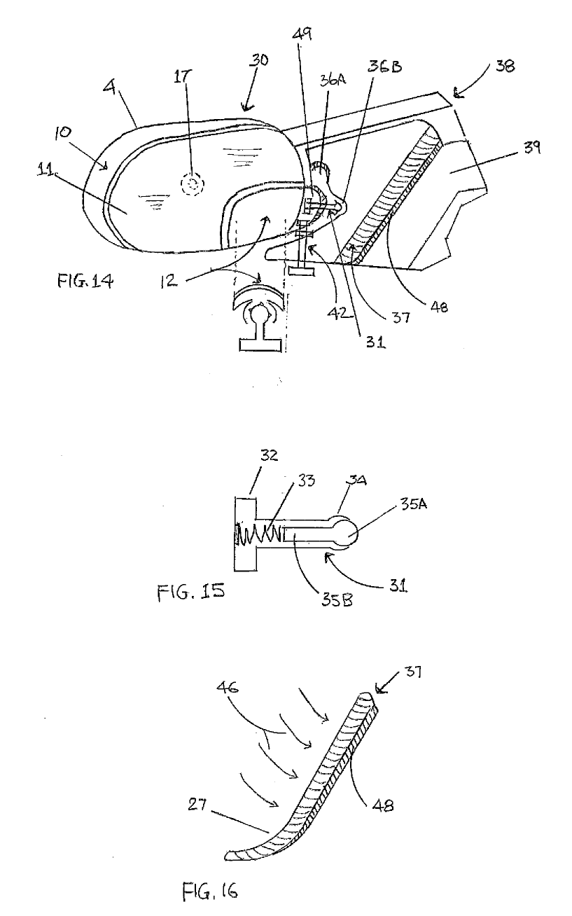

FIG. 6 is an illustration of a rear view blind-spot mirror assembly 21B comprising a mirror 16, a horizontal socket 23 for horizontal installation, a vertical socket 24 for vertical installation which in prior submitted drawing missed to name the horizontal socket locking tip23A, the purpose of which is to hold the ball 15A in place without dislodging such ball 15A out of horizontal socket 23, but still has the ability to move the mirror 16 at 360 degree rotation. The vertical socket locking tip 24A was in the drawing but was not properly disclosed as well, the purpose of which is to hold the ball 15A in place without dislodging such ball ISA out of vertical socket 24 but retains the ability of mirror 16 not only to be moved 360 degree rotation but also can be freely be moved up or down to best meet the driver's need to view not only the left or right blind spot corners but also watch the baby if any buckled down in a car seat and/or just seating at any rear passenger seat.

FIG. 23 is one of the embodiments comprising locking gear tooth 553 and locking gear tooth/electric contact 55C which can also be adapted to become electrical connectors which can now be referred to as locking gear tooth/electrical connector 55B and locking rear tooth/connector 55C, that can now be used not only as a stopper but also as a means to cut off electrical power to the motor for the purpose of stopping the motor rotation thus in effect stopping the movement of side mirror assembly 30 to its intended proper position. The other electrical contact can be implemented through an opening plate electrical contacts 69A and 69B as shown in FIG. 25 that may be located at opposite edges adjacent to receptor plate 68 or at any other location that may be suitable in implementing the completion of the electrical circuit in controlling DC Motors 60 and 62 respectively.

FIG. 51 in accordance with an embodiment comprising front-end locking gear Tooth/electric contact 55C and back-end locking gear tooth/electric contact 55B can also be adapted to become electrical contacts that can be used to cut off electrical power to the motor for the purpose of the stopping the movement in lifting mirror 11 at its highest point when the front end gear tooth/electrical contact 55B makes contact with the upper reduction gear cavity electric contact 87A thus completing the electrical circuit in stopping the movement of DC motors 80,81,94,95 as shown in FIG. 28 and FIG. 51. The reduction gear cavity electric contact may be implemented at any other location that may be suitable in completing the electrical circuit of the electric motors.

FIG. 52 in accordance with an embodiment comprising mirror 11 at its lowest position in which the back end locking gear tooth/electric contact 55C is also adapted to become an electrical contact that can be used to cut off electrical power to the motor for the purpose of stopping the motor rotation thus stopping the movement of mirror 11 at proper desired position when the rear end gear tooth/electrical contact 55C makes contact with the lower reduction gear cavity electric contact 87B thus completing the electrical circuit in stopping the movement of DC motors 80, 81, 94, 95 as shown in FIG. 28 and FIG. 52. The reduction gear cavity electric contact may be implemented at any other location that may be suitable in completing the electrical circuit of the electric motors.

FIG. 58 shows an embodiment illustrating a computer mirror 133 as shown in FIG. 32 comprising mirror 16, movable frame 134, support 138 as shown in FIG. 34, a webcam/microphone 224, a movable arm 200, a choice of ball assemblies between a fixed 18A as shown in FIG. 4, or an adjustable 18B as shown in FIG. 3, may be implemented by integrating the computer mirror into a case of a computer monitor 160, a laptop computer screen case or any other device that requires rear view privacy for a user. A user is defined as a person or a computer monitoring system who wants a privacy protection from other person or other computer monitoring devices such as video cam or any other recording type devices that record images by preventing another person or persons or a computer monitoring device to see what the user is typing, reading or developing in a computer monitor, laptop screens or any other type of viewable recording devices.

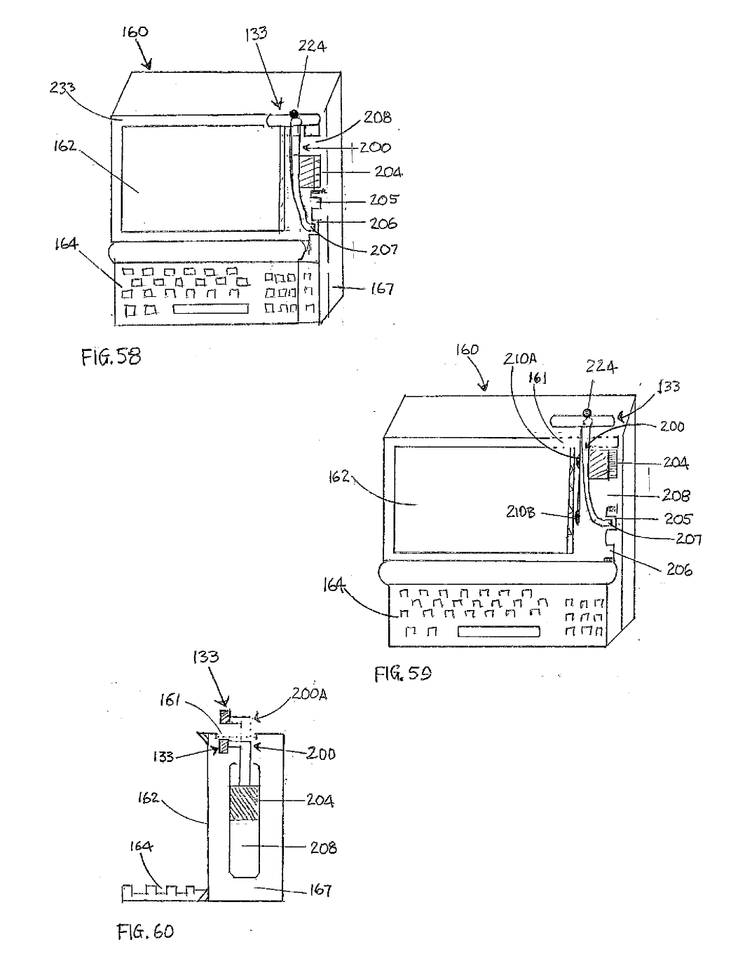

FIG. 62 shows one of the ways an arm assembly 200 can be configured, comprising a flexible arm 203 which may be configured to be permanently bent at almost a 90 degree angle, with physical characteristics of being durable and flexible, a movable arm locking tip 207, an upper V guide 210A, a lower V guide 210B which can be made out of hard plastic, nylon and any broad variety of material as shown in FIG. 65, a wheel assembly 209 which can be made out of hard plastic, nylon and any broad variety of material consisting of a wheel shaft 209A and a wheel 209B as shown in FIG. 64, the purpose of which is to guide the arm assembly 200 through wheel 209 via a vertical V rail 214 as shown in FIG. 61 up or down by way of slide arm button 204. The flexible arm can be made out of any broad variety of flexible materials that may include plastic, nylon and almost any other flexible material. FIG. 63 shows another way in which movable arm assembly 200 may be implemented, by adding a locking arm spring 211 that can be located at the back of movable arm locking tip 207 for additional flexibility support. In accordance with this embodiment, the upper V guide 210A and lower V guide 210B can be configured by a using a half wheel type V guide as shown in FIG. 65. FIG. 60 shows side view of computer 160 in which two configurable setups are shown one having the movable arm assembly 200 at a park position meaning the mirror 133 and webcam/microphone 224 are inside the computer or terminal case upper case cavity 161 as shown in FIG. 58. In another example, the mirror, the webcam/microphone as attached to the movable arm assembly 200A is now in an extended position being displayed over the top of a computer terminal or laptop screen upper edge 233 in which case the mirror and webcam/microphone are now ready for privacy protection use as shown in FIG. 59.

In use when the user presses the slide arm button 204 inward from park position and if using movable arm assembly 200 as shown in FIG. 62 unlocks the movable arm locking tip 207 off of lower lock cavity 206, and while pressing and pushing the slide arm button 204 upward, the upper guide 210A then glides by way of inner guide 212 unto rail ridge 215 and guides the wheel 209 as shown in FIG. 64 as it rolls over unto the rail ridge and as being guided accordingly by left V rail wall 217 and right V rail wall 216 as shown in FIG. 61 and then followed by the lower guide 210B for balance and smoothness until the movable arm locking tip 207 locks into place with upper lock cavity 205 then the mirror and the webcam/microphone are now above the computer case upper edge 233 and ready for use as shown in FIG. 59. The reverse of the process is done to place mirror 133 and webcam/microphone 224 back into park position as shown in FIG. 58. Alternatively, if by using movable arm assembly 200 as shown in FIG. 63 the process would be similar to the one shown in FIG. 62 except for the missing wheel 209 and now the addition of a locking arm spring 211. When the user presses the slide arm button 204 inward the locking arm spring 211 is compressed and from its park position then unlocks the movable arm locking tip 207 off of lower lock cavity 206, and while pressing and pushing the slide arm button 204 upward, the upper guide 210A then glides by way of inner guide 212 unto rail ridge 215 and as being guided accordingly by left V rail wall 217 and right V rail wall 216 as shown in FIG. 61 and then followed by the lower guide 210B for balance and smoothness until the movable arm locking tip 207 locks into place with upper lock cavity 205 then the mirror and the webcam/microphone are now above the computer case upper edge 233 and ready for use as shown in FIG. 59.

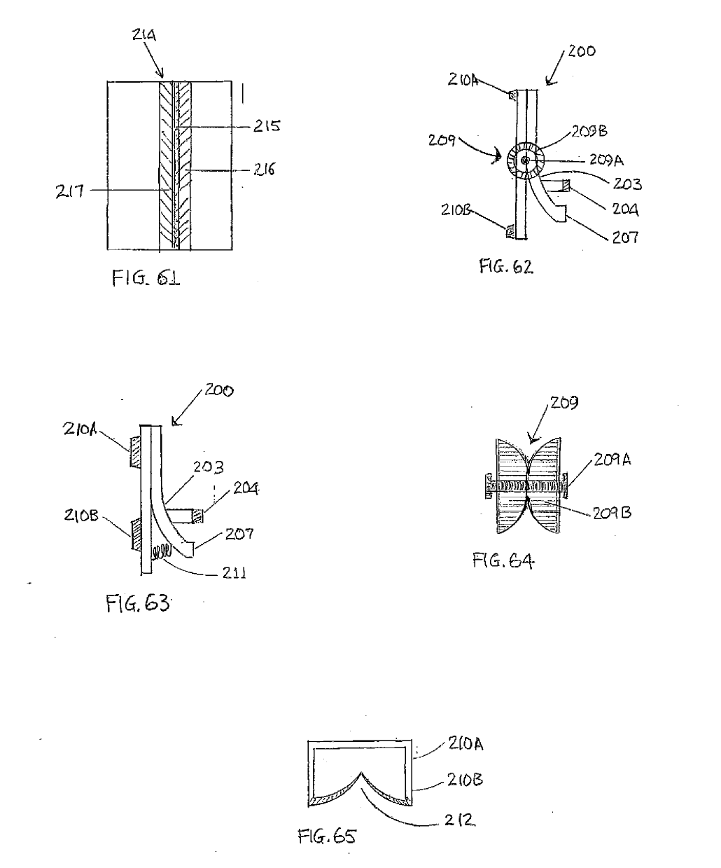

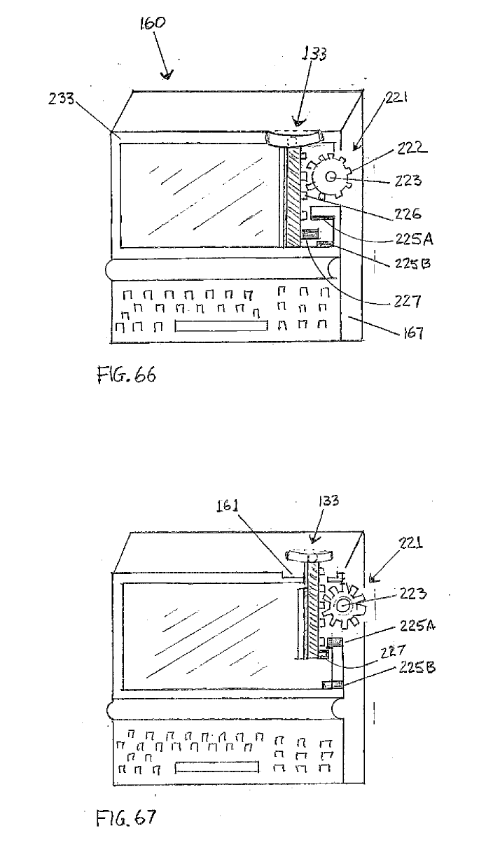

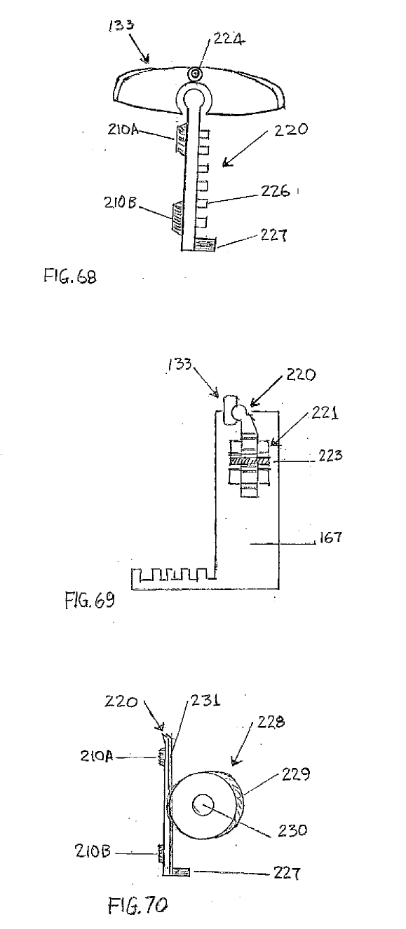

FIG. 66 is another illustration of a computer mirror 133 comprising a movable locking gear arm 220, a wheel gear assembly 221, an upper locking bar/electrical contact 225A, a lower locking bar/electrical contact 225B, a choice of ball assemblies between a fix 18A as shown in FIG. 4, or an adjustable 18B as shown in FIG. 3, may be implemented by integrating such computer mirror 133, a webcam/microphone 224 into the case of a computer monitor 160, a laptop computer screen case or any other computer devices that require rear view privacy of a user and lifted or lowered by means of a rotating wheel 221. In accordance with an embodiment as shown in FIG. 68, there is the mirror, the webcam/microphone, an arm gear 226, arm locking gear/electrical contact 227, the upper guide 210A and lower guide 210B.

When in use the user simply rolls or presses the exposed wheel gear 221 which rotates on shaft 223 off of the side of a computer monitor or laptop screen case 167 down in which the wheel gear 222 engages with arm gear 226 resulting in the lifting of the movable locking gear assembly 220 and while the movable locking gear assembly 220 is being lifted upward, the upper guide 210A then glides by way of inner guide 212 as shown in FIG. 65 unto rail ridge 215 and as being guided accordingly by left V rail wall 217 and right V rail wall 216 as shown in FIG. 61 and then followed by the lower guide 210B for smoothness and balance. As the user continue to turn the exposed wheel gear 221 downward the movable locking gear assembly 220 will continue to rise until the arm locking gear/electrical contact 227 gets block by upper locking bar/electrical contact 225A and then the movable locking gear assembly 220 stops moving upward exposing the mirror 133 and webcam/microphone 224 above the frontal edge of the computer case 233 and is now ready to protect the privacy of any user. The process would be in reverse in bringing the mirror 133 down for storage, in which the user would roll or press the exposed wheel gear 221 upward until such a time that the arm locking gear/electrical contact 227 mesh with the lower locking bar/electrical contact 225B stopping the movable gear assembly 220 downward movement. FIG. 69 shows what the side of the computer case 167 would look like comprising the mirror 133, the movable locking gear assembly 220, the wheel gear assembly 221 and wheel shaft 233.

FIG. 70 according to one embodiment shows another method of lifting and lowering the movable locking gear assembly 200, comprising a movable arm rubberized coated flat surface contact 231, a rubberized wheel assembly 228 as an alternative to other previously described processes of lifting and lowering of mirror 133.

When in use, the user simply rolls or presses the exposed rubber wheel assembly 228 which rotates on shaft 230 off of the side of a computer monitor or laptop screen case 167 downward in which the wheel with rubberized flat surface area 229 engages with the movable arm rubberized flat surface 231 resulting in the lifting of the movable locking gear assembly 220 and while the movable locking gear assembly 220 is being lifted upward, the upper guide 210A then glides by way of inner guide 212 as shown in FIG. 65 unto rail ridge 215 and as being guided accordingly by left V rail wall 217 and right V rail wall 216 as shown in FIG. 61 and then followed by the lower guide 210B for smoothness and balance. As the user continues to turn the exposed rubberized wheel 228 downward the movable locking gear assembly 220 will continue to rise until the arm locking gear/electrical contact 227 gets block by upper locking bar/electrical contact 225A and then the movable locking gear assembly 220 stops moving upward exposing the mirror 133 and webcam/microphone 224 above the frontal edge of the computer case 233 and is now ready for use to protect the privacy of any user. The process would be reversed in bringing the mirror 133 down for storage, in which the user would roll or press the exposed rubberized wheel 228 upward until such a time that the arm locking gear/electrical contact 227 meshes with the lower locking bar/electrical contact 225B stopping the movable gear assembly 220 downward movement.

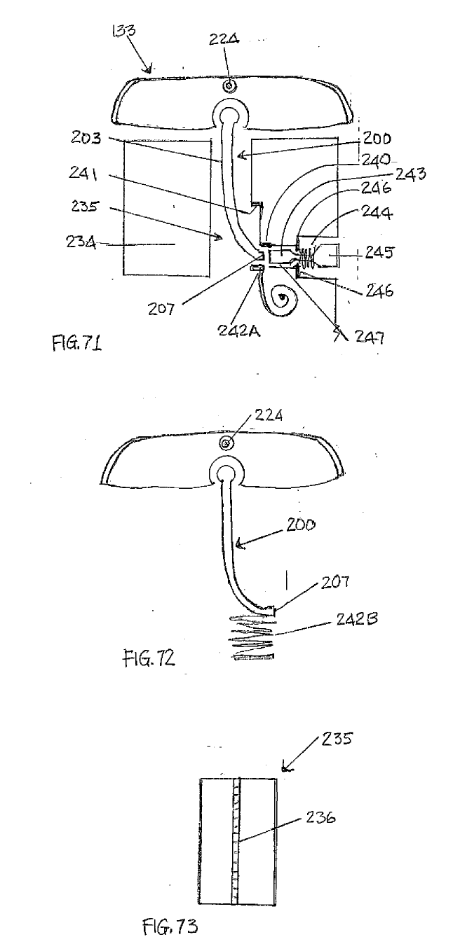

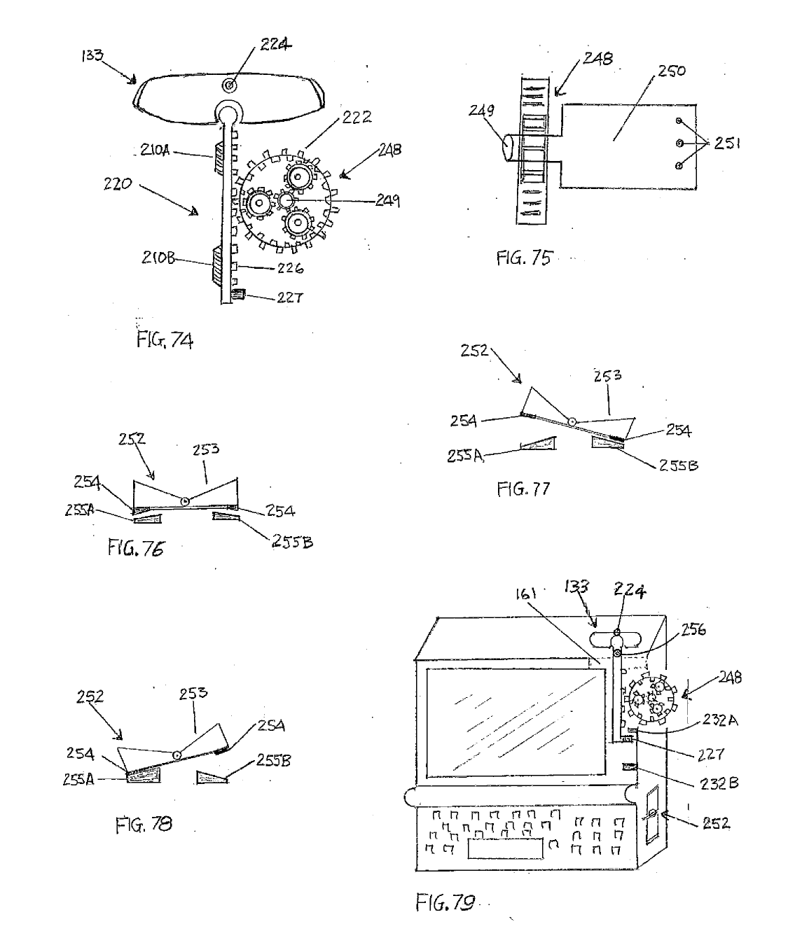

FIG. 71 according to one embodiment shows another method of lifting and lowering the movable arm assembly 200, comprising a movable arm locking tip 207 whose purpose is to lock the movable arm assembly 200 in an upward position where mirror 133 is above the frontal edge of computer case 233 when engages with the upper locking tip stopper 241 or at park position where the movable arm locking tip 207 engages with that of the lower locking tip stopper 240, a flexible arm 203 whose function is to provide flexibility in controlling the locking and unlocking with that of the upper locking tip stopper 241 and lower locking tip stopper 240, a clock type lift spring 242A whose purpose is to push the movable locking arm assembly upward and be compressed for downward movement towards the park position of the movable locking arm assembly, a push rod tip 243 that sits in push rod cavity 247 and supported by push rod spring 244 and push rod button 245 whose function is to push movable arm locking tip out of engagement with that of the lower locking tip stopper by way of push rod button. Flexible arm 203 can be made out of plastic, nylon or any other type of flexible material in which the movable arm locking tip can be more or less 90 degree angle bent that if pushed will always revert back to its original orientation without breakage. FIG. 72 is another illustration in which lift clock type spring 242A can be substituted by a lift coiled type spring 242B to push the movable locking arm assembly 200 upward and be capable of compression when mirror 133 is pressed down for its parking position. FIG. 73 is the illustration of a computer monitor cavity wall 235 and an indentation 236 the purpose of which is to guide the flexible arm 203 during its upward movement for use position and downward movement for its storage.

In operation, the user pushes push rod button 245, compresses push rod spring 244 then the push rod tip 243 pushes the movable arm locking tip 207 disengaging from the lower tip stopper 240 enabling the lift spring 242A or lift spring 242B to push the movable locking arm assembly 200 upward by gliding back at the side of flexible arm 203 against the indentation 236 of the cavity wall 235 as shown in FIG. 73 until the movable arm locking tip 207 engages with the upper locking tip stopper 241 resulting in the lifting of mirror 133 and webcam/microphone 224 making them ready for use as shown in FIG. 59, FIG. 67 and FIG. 79. The user then releases the push rod button 245 back to its original position by way of the uncompressing push of rod spring 244. When the user is done working on the computer terminal, laptop screen or any other monitoring screen devices, the user then just presses the mirror 133 downward enabling the lift spring 242A or 242B to be compressed enabling the movable arm locking tip 207 to slide downward until it engages with the lower locking tip stopper 240 at which time the mirror 133 then fits snugly unto the upper case cavity 161 as shown in FIG. 58 and FIG. 66.

FIG. 74 is another illustration of a computer mirror 133 comprising a movable locking gear assembly 220, a planetary gear assembly 248 the purpose of which is to be able to lift the movable locking gear assembly 220 upward or downward, a choice of ball assemblies between a fix 18A as shown in FIG. 4, or an adjustable 18B as shown in FIG. 3, may be implemented by integrating such computer mirror 133 into the case of a computer monitor cavity 161, a laptop computer screen case cavity 161 as shown in FIG. 79 or any other computer devices that may require rear view privacy for a user. In accordance with an embodiment as shown in FIG. 74, there is a mirror 133, a webcam/microphone 224 integrated into the mirror 133, the movable arm gear assembly 220, the arm locking gear/electrical contact 227, the upper guide 210A and lower guide 210B. In FIG. 76 shows the motor switch 252 at its neutral position, while FIG. 77 shows electrical contact 254 in contact with electrical stationary contact 255B which as an option could be interpreted as turning on the switch to move the mirror 133 down towards its park position, while FIG. 78 shows contact 252 in contact with that of electrical stationary contact 255A which can be interpreted as turning on the switch to raise mirror 133 off of its park position until the arm locking gear/electrical contact 227 touches the upper case stopper/electrical contact 232A sending a signal to the motor 250 to stop turning thus making mirror 133 along with webcam/microphone 224 ready for use. FIG. 75 is an illustration of a motor preferably a DC motor or it can be of any other type of motor that is controllable, that would be capable of rotating motor shaft/gear 249, the purpose of which is to be engaged with planetary gearing assembly 248 that will provide the upward lift or downward movement of the movable locking gear assembly 220 which can be controlled electronically through motor electrical connectors 251.

When in use the user simply presses the external switch 252 up or down as shown in FIG. 79 by either choosing options FIG. 77 which in effect electrical contact 254 makes contact with electrical stationary contact 255B electrical signal is sent to the motor 250 to rotate its motor shaft/gear 249 which in turn rotates the planetary gear assembly 248 that its wheel gear 222 meshes with arm gear 226 until the arm locking gear/electrical contact 227 makes contact and gets block by the lower case stopper/electrical contact 232B and at the same time sends electrical signal to motor to stop turning thereby placing the mirror at its parking position. Alternatively, FIG. 78 is activated when electrical contact 252 makes contact with electrical stationary contact 255A electrical signal is sent to the motor to rotate its motor shaft/gear which in turn rotates the planetary gear assembly that through its wheel gear meshes with arm gear until the arm locking gear/electrical contact makes contact and gets block by the upper case stopper/electrical contact 232A and at the same time sends an electrical signal to the motor to stop turning thereby placing the mirror and webcam/microphone out of upper case cavity 161 and it is now ready for use as shown in FIG. 79.

FIG. 80 according to one embodiment shows another method of lifting and lowering the movable arm assembly 260 with the aid of rotatable shaft 267 which can be rounded or angular in shape, comprising a mirror 133, a webcam/microphone 224, a choice of ball assemblies between a fix 18A as shown in FIG. 4, or an adjustable 18B as shown in FIG. 3, may be implemented by lifting up the mirror/webcam/microphone from back case 271 as shown in FIG. 81 off of a computer monitor, a laptop computer screen case or any other computer devices that may require rear view privacy of a user.

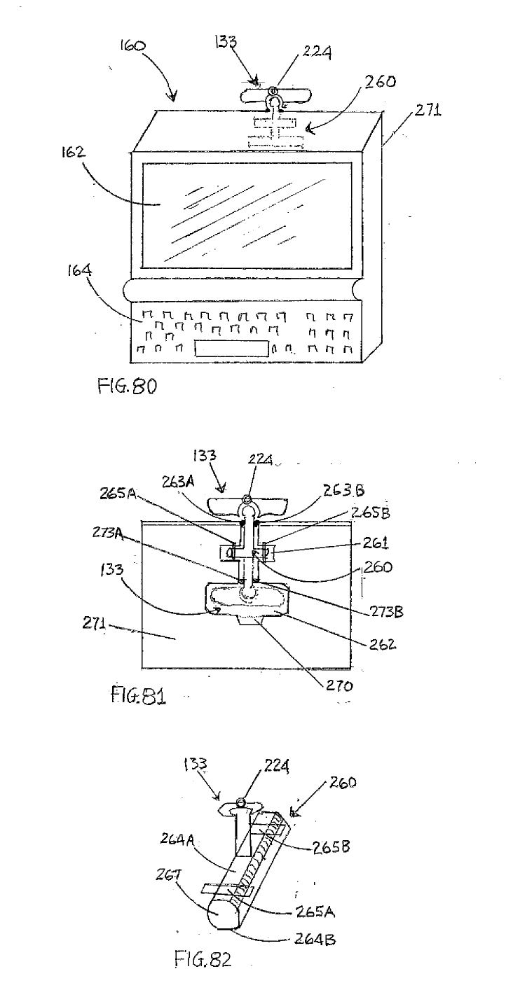

In accordance with one embodiment, the arm movable assembly as shown in FIG. 82 comprising the mirror, the webcam/microphone, a top shaft flat surface 264A and a bottom shaft flat surface 264B the purpose of which is to hold the arm movable assembly in an upright or storage positions when engaged with the left and light shaft flat holders 265A and 265B. The shaft flat holders can be made out of rubber, synthetic rubber, plastic, nylon or may be of any other pliable material. FIG. 85 shows the mirror in its storage position after being pulled from the upright position 180 degrees down through the rotation of the rotatable shaft into a mirror cavity 262 as shown in FIG. 81 at which time the bottom shaft flat surface 264B engages with the left and right shaft flat holders for a secured storage. FIG. 84 shows a back case 271, a back case cavity 272 comprising a shaft cavity 261 the purpose of which is to hold the rotatable shaft in by a pair of the shaft flat surface holders that locks the mirror in either ready for use or the storage position, a mirror cavity 262 the purpose of which is to house the mirror/webcam/microphone and a lift case cavity 270 the purpose of which is provide an opening for prying out the mirror out of its storage position to the upright ready to use position.

In use, the user would from the lift case cavity 270 pry out and the lift the mirror/webcam/microphone up out of mirror cavity 262 while the left and right shaft flat holder 265A and 265B releases the shaft flat surface 264B and while the rotatable shaft 267 is turning 180 degrees towards the top of a computer monitor or a laptop computer screen case at which case the left and right shaft flat holder 265A and 265B engages and locks up with the shaft flat surface 264A. The mirror along with the webcam/microphone is now up and locked and is now ready for use. The process is reversed when storing the mirror back to its storage position inside mirror cavity and locked up the rotatable shaft's bottom shaft flat surface by the left and right shaft flat holders and by the left and right lower stationary tips.

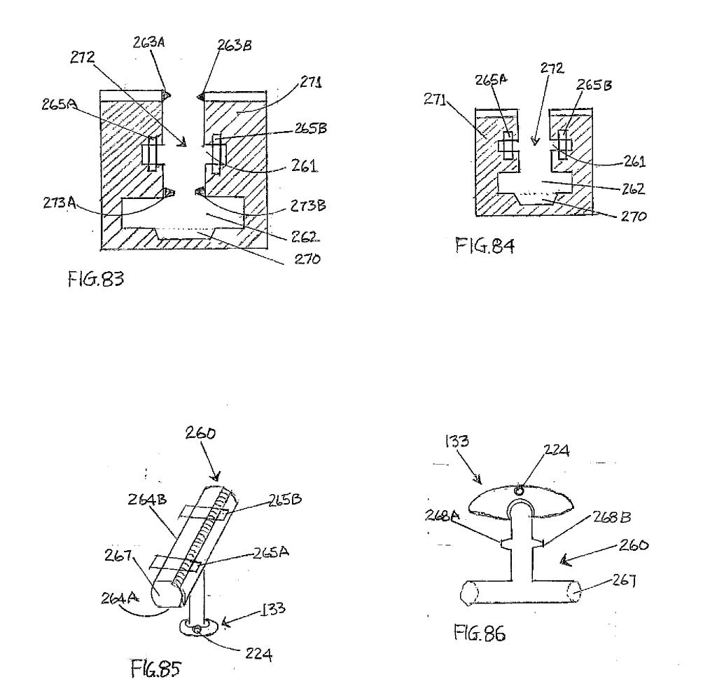

In accordance with one embodiment, the arm movable assembly 260 as shown in FIG. 86 comprising a mirror 133, a webcam/microphone 224, a left protrusion 268A, a right protrusion 268B whose purpose is to hold the arm movable assembly at its locked upright position (the ready use position) when the left upper stationary tip 263A and right upper stationary tip 263B engage with the left and right protrusions or to hold the arm movable assembly at its locked storage position when the left and right protrusions engage with the left lower stationary tip 273A and right lower stationary tip 273B as shown in FIG. 83. These stationary tips can be made out of natural or synthetic rubber or may be of any other pliable material. FIG. 83. shows a back case 271 of a computer monitor, a laptop computer screen case or any other computer devices that may require rear view privacy of a user, an upper left stationary tip 263A, an upper right stationary tip 263B, the purpose of which is to lock up the mirror in an upright (the ready use position), a back case cavity 272 comprising a shaft cavity 261 the purpose of which is to hold the rotatable shaft 267 in by a pair of the shaft flat surface holders 265A and 265B that locks the mirror in either upright ready for use or in folded storage position, a mirror cavity 262 the purpose of which is to house the mirror/webcam/microphone and a lift case cavity 270 the purpose of which is provide an opening for prying out the mirror out of its storage position and being pulled-up into the upright ready to use position.

In use the user would from the lift case cavity 270 pry out and the lift the mirror 133 up out of mirror cavity 262 while the left and right lower stationary tips 273A and 273B releases the left and right protrusions 268A and 268B and while the rotatable shaft 267 is turning 180 degrees towards the top of a computer monitor or a laptop computer screen case at which case the left and right protrusions 268A and 268B engages and locks up with the left and right upper stationary tips 263A and 263B. The mirror along with the webcam/microphone is now up and locked and is now ready for use. The process is reversed when storing the mirror back to its storage position inside mirror cavity and the movable arm assembly 260 is locked up by the lower left and right stationary tips.

It will be apparent to a skilled artisan that the embodiments described above are exemplary of inventions that may have a greater scope than any of the singular descriptions. There may be many alterations made in these examples without departing from the spirit and scope of the invention. For example, mirror/webcam/microphone placements may be configured in several different ways. Mirror/webcam/microphone can be lifted up and put into storage in several configurations like pressing the slide arm button and pushing it upward and downward or rotate a geared wheel clockwise to raise the mirror/webcam/microphone upward or rotate the geared wheel counter clockwise to lower the mirror/webcam/microphone into its storage position. The mirror/webcam/microphone can also be lifted up through by rotating the rubber wheel assembly clockwise to lift or rotating it counter clockwise to lowers the mirror/webcam/microphone into its storage. One other way to lift the mirror/webcam/microphone may be the use of spring loaded movable locking arm that can be triggered by pressing the push rod button and can be returned into its storage position by pressing the mirror/webcam/microphone down until the movable arm locking tip locks into with the lower locking tip stopper. One other configuration may be the use of electric motor to lift and store the mirror/webcam/microphone that may be activated by way of the provided electrical switch.

The mirror/webcam/microphone can also be lifted up and stored from the back of computer monitor case or laptop screen case by prying the mirror/webcam/microphone from its storage position off of lift case cavity by lifting such mirror/webcam/microphone up towards the front of the computer monitor case or laptop screen case until the upper stationary tips locks with that of the left and right protrusions. The reverse process would be to push the mirror/webcam/microphone towards the back of the computer monitor case or laptop screen case until the left and right protrusions engage with the left and right lower stationary tips thereby making the mirror/webcam/microphone lies at the mirror cavity in its storage position.

These and many other features may change in different embodiments.

According to one embodiment, as shown in FIG. 3 and FIG. 4, the ball protrusions 15B as previously described have been segregated into two distinct components namely, the squared hardened flat top protrusion 15C and the pointed flexible top protrusion 15D. The tip of the pointed flexible top protrusion 15D may be any of a broad variety of materials that may include but not limited to nylon, plastic, medium to hard rubber, or any other pliable material.

One of the purposes of having a pliable tip for the pointed flexible top protrusion will be to attain a lockable and yet retain the mobility for the mirror 133 to be moved for the desired blind-spot setup positioning against the socket 17 flat, hardened interior wall mounting surface 28. In use, when the driver moves the mirror, the squared hardened flat top protrusion 15C easily slides over the hardened interior wall 28 of socket assembly 17, while the pointed flexible top protrusion 15D slides with resistance against the hardened interior wall 28 of socket assembly 17 thereby locking the mirror position in place when the movement stops.

According to another embodiment, as shown in FIG. 91, the interior wall mounting surface 28 of socket assembly 17 as shown in FIG. 4, may be implemented by coating the socket interior wall 194 by any pliable material which may include but is not limited to any plastic, nylon, rubberized material or any other flexible and/or elastic material. In this embodiment the tips of ball protrusions 15B comprising squared flat top 15C and pointed flexible top 15D will be both hardened. In use, when the driver moves the mirror, the squared hardened flat top protrusion 15C and the pointed top protrusion 15D slides with resistance against the coated interior wall 28 of socket assembly 17 thereby locking the mirror position in place when the movement stops.

According to one embodiment, as shown in FIG. 32, comprising the different types of holders for attaching a paper note, a posted note, a photograph, telephone number or other medium for reminders to the user that may be attached to fix frame 132 or adjustable frame 134. In one case, the use of two attracting permanent magnets, one being the fixed permanent magnet 191, that may be permanently attached to the back of the fix frame 132, and the other the movable permanent magnet 192 that may be placed at the top of fix frame 132, as shown in FIG. 34. In another case, applying layers of adhesive 132A that will permanently sticks to frames 132 and 134, but when you attached a paper, a photograph it will stick to such adhesive layer with the option of removal from such adhesive layered frames. In this embodiment, said adhesive layer 132A can be used and reused by attaching and removing paper, photograph or any other material that will stick to this said adhesive layer. In use, the user simply places the posted note, photograph, telephone number or other medium for reminders on top of fixed frame 132 by either attaching on top of layer of adhesive or placing them between the movable permanent magnet 192 and fixed magnet 191. In another case, the use of an alligator type clip holder 193, as shown in FIG. 33, comprising a fixed arm 198, which may be permanently affixed to mirror support 138, a fixed tip 197, a movable tip 196 and a spring loaded movable arm 195. In use, the user simply presses the movable arm 195 to open up the clearance between fixed tip 197 and movable tip 196, insert the posted note, photograph, telephone number or other medium for reminders and then release the movable arm 195 back to its original position. The posted note, photograph, telephone number or other medium for reminders will be now be available for use.

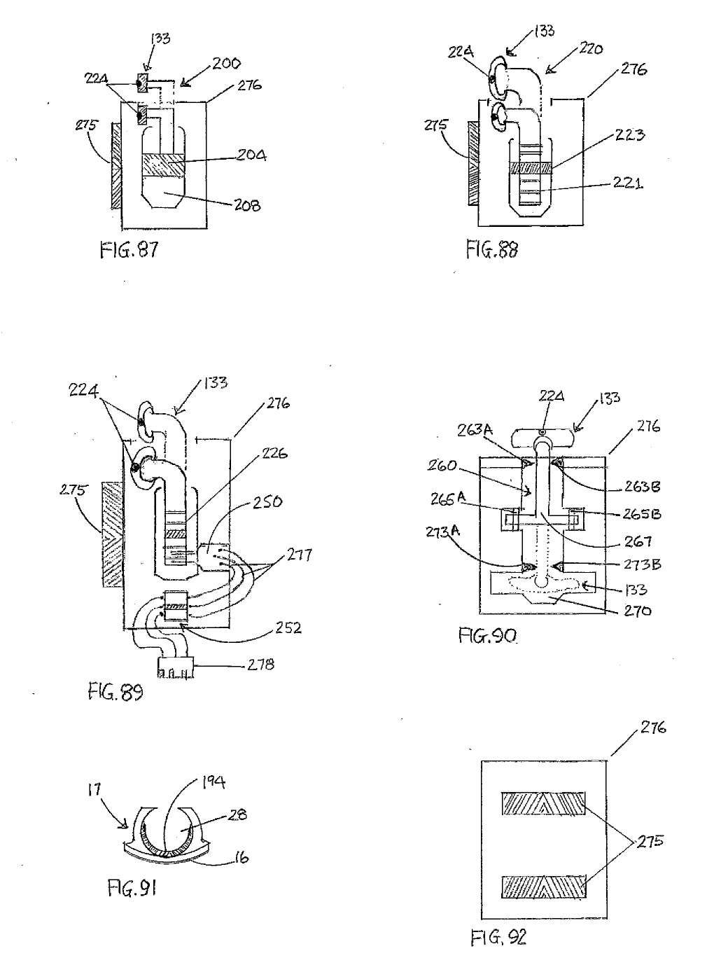

According to one embodiment, as shown in FIG. 87, comprising an external privacy mirror assembly, an adhesive mounting layer 275, a privacy mirror 133, a movable locking assembly 200, a webcam/microphone 224, a slide arm button 204 and a computer slide arm cavity 208. The adhesive mounting layer 275, may include, without limitation a rubberized or any flexible backing material that adhesive can be applied to, Velcro or any other flexible wires that can be used to anchor the privacy mirror assembly unto the side or back of a computer case 167. The structure and internals of FIG. 87 have been described previously as integrated units into the computer case 167 as shown in FIG. 40, 43, 45, 58, 59, 60 and may be implemented as an external unit instead of as an internal unit. In use, the user attaches the external privacy mirror assembly case 276 via adhesive mounting layer 275 unto the back of a computer 167. In this embodiment, the user presses side arm button 204, pushes the side arm button upward and the mirror 133 and webcam/microphone 244 are now ready for use. The reverse process starts by pressing the side arm button 204 downward until the movable locking tip 207 locks into lower lock cavity 206, then the mirror/webcam/microphone are now safely stored.

According to another embodiment, as shown in FIG. 88, comprising a mirror 133, a webcam/microphone 224, a movable locking gear arm 220, an external privacy mirror assembly case 276, a wheel shaft 223, a wheel gear 221 and an adhesive mounting layer 275. In this embodiment, the structure and internals have been described previously as integrated units into the computer case 167 as shown in FIG. 66 67, 71, 72 and may be implemented as an external unit and such structure and internals comprising the mirror 133, webcam/microphone 224, movable locking gear assembly 220, gear wheel assembly 221 contained in the external privacy mirror assembly case 276, and can be installed at the back or side of a computer case 167. In use, the user activates the mirror/webcam/microphone by pressing/rotating wheel gear 222 downward which in turn lifts the movable locking gear assembly 220 upwards until the arm locking gear/electrical contact 227 gets block by the upper locking bar/electrical contact 225A. In this situation, the upward movement of the movable locking gear assembly 220 stops and the mirror/webcam/microphone is now up and ready for use. The process is reversed in storing the mirror/webcam/microphone into the storage position. The user presses wheel gear 222 upward thereby making the movable locking gear arm assembly 220 moves downward until the arm locking gear/electrical contact 227 makes contact with the lower locking bar/electrical contact 225B, then the mirror/webcam/microphone is now stored and hidden inside the upper case cavity 161.

According to another embodiment, as shown in FIG. 89, comprising a mirror 133, a webcam/microphone 224, an external privacy mirror assembly case 276, an arm gear 226, a motor 250, electrical wires 277, the purpose of which is to connect the motor to the motor switch 252, a USB connector 278 that can then be plug in at any available USB socket unused and can be installed at the back or side of a computer case 167 by way of adhesive mounting layer 275. In this embodiment, the structure and internals have been described previously as integrated units into the computer case 167 as shown in FIG. 74, 75,76, 77, 78, 79 and may be implemented as an external unit and such structure and internals comprising the mirror 133, webcam/microphone 224, movable locking gear assembly 220, planetary gears 248, a motor 250, a motor switch 252 contained in the external privacy mirror assembly case 276, and can be installed at the back or side of a computer case 167 by the use of adhesive mounting layer 275. In use, the user activates the mirror/webcam/microphone to move upward out of upper case cavity 161 by pressing switch 252 as shown in FIG. 78,79 in which the motor shaft/gear 249 rotates the planetary gears 248 pushing movable locking gear 220 upward until the arm locking gear/electrical contact 227 makes contact with the upper case stopper/electrical contact 232A stopping the movement upward of movable locking gear arm 220 and at the same time cutting off the electrical power to motor 250 stopping the upward movement. The process for storage is the reverse of bringing the mirror/webcam/microphone up. The user then presses switch 252 as shown in FIG. 77, 81 in which the motor shaft/gear 249 rotates the planetary gears 248 pushing movable locking gear 220 downward until the arm locking gear/electrical contact 227 makes contact with the lower case stopper/electrical contact 232B stopping the movement downward of the movable locking gear arm 220 and at the same time cutting off the electrical power to motor 250 stopping the downward movement. The mirror/webcam/microphone is now in storage position and hidden inside the upper case cavity 161.

According to another embodiment, as shown in FIG. 90, comprising a mirror 133, a webcam/microphone 224, an external privacy mirror assembly case 276, a left and right upper stationary tips 263A, 263B, a rotatable shaft 267, a left and right flat holders 265A, 265B, a left and right lower stationary tips 273A, 273B, a lift cavity case 270 and can be installed at the back or side of a computer case 167 by way of adhesive mounting layer 275 as shown in FIG. 92. In this embodiment, the structure and internals have been described previously as integrated units unto the computer case 167 as shown in FIG. 80, 81, 82, 83, 84, 85, 86 and may be implemented as an external unit and such structure and internals comprising the mirror 133, webcam/microphone 224, movable arm assembly 260, rotatable shaft 267, left and right upper stationary tips 263A,263B, left and right shaft flat holders 265A,265B, left and right lower stationary tips 273A,273B, lift case cavity 270 and can be installed at the back or side of a computer case 167 via adhesive mounting layer 275. In use, the user would from the lift case cavity 270 pry out and the lift the mirror/webcam/microphone up out of mirror cavity 262 while the left and right shaft flat holder 265A and 265B releases the shaft flat surface 264B and while the rotatable shaft 267 is turning 180 degrees towards the top of a computer monitor or a laptop computer screen case at which case the left and right shaft flat holder 265A and 265B engages and locks up with the shaft flat surface 264A. The mirror along with the webcam/microphone is now up and locked and is now ready for use. The process is reversed when storing the mirror back to its storage position inside mirror cavity and locked up the rotatable shaft's bottom shaft flat surface by the left and right shaft flat holders and by the left and right lower stationary tips.

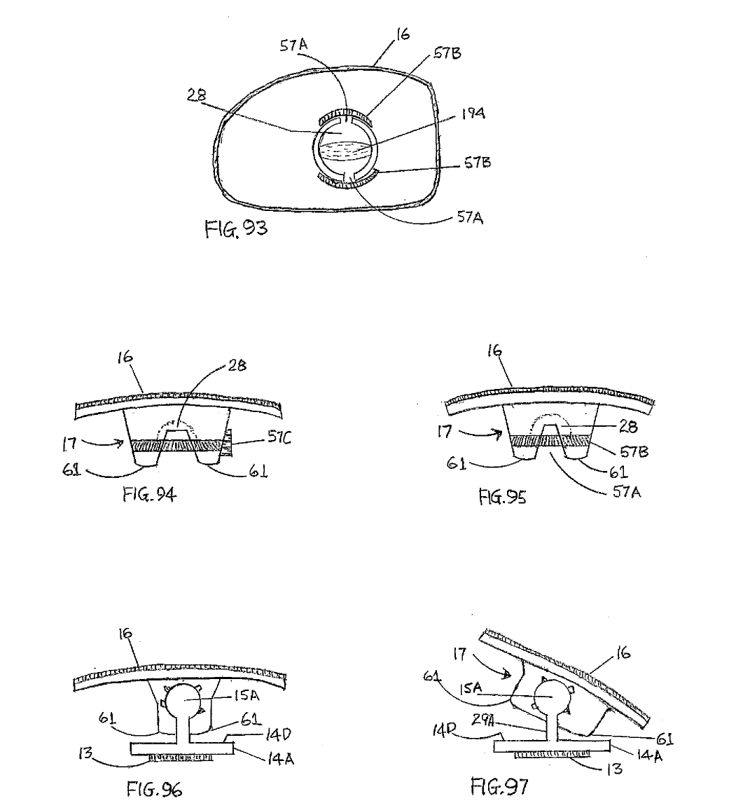

According to another embodiment, as shown in FIG. 93, comprising a mirror 16, with or without a socket interior coating 194, a socket slit 57A, the purpose of which is to provide an easy installation of ball 15A, a socket slit holder 57B, the purpose of which is to strengthen socket 17 in holding the ball 15A inside the interior mounting surface 28, application of which is done after the ball and socket have been mated. The socket slit holder 57B may be glued on or molded into the outside corner of socket 17. In accordance with an embodiment, as shown in FIG. 95, comprising a mirror 16, an interior mounting surface 28, a socket slit holder 57B, a socket bottom guide 61, the purpose of which may be to limit the angle travel of mirror 16 and add additional strength for the ball 15A not to be easily pulled out from socket 17 as shown in FIG. 97 and yet still has the full capability for the mirror to be moved at 360 degrees rotation. According to another embodiment, FIG. 94 shows another way of strengthening the socket assembly 17 by using a socket screw holder 57C. In this case, the two socket bottom guides 61 will be joined and held in stable position by driving the socket screw holder 57C in between them thereby holding the ball 15A inside the interior mounting surface 28 of socket assembly which can have a pliable coating or no coating at all. In some situation, for example, when the user goes to have his vehicle wash in an automatic car wash, the socket assembly 17 needs to withstand the force by the rotating brushes of the automatic car washing equipment. In accordance with an embodiment, as shown in FIG. 97, when the socket assembly 17 gets tilted by the car wash rotating brush, the socket bottom guide 61 is pressed against the base top surface 14D thereby assisting the socket slit holder 57B or the socket screw holder 57C secure the ball 15A into the interior mounting surface of socket assembly 17.

In accordance with FIG. 80-86, according to an alternative embodiment, the embodiment shown by FIG. 81 may be adopted to be installed, in addition to the back case 271, off of a computer monitor, a laptop computer screen case or any other computer devices that may require rear view privacy of a user, and may be adopted and can be configured and be installed at either left or night sides of a laptop case, computer screen case, or monitor, or any other computer devices 167 as shown in FIG. 87-90.

Modifications to some elements, such as, for example, rotatable shaft 267, may be required. 267 may have to be shortened, orientation of mirror 133 may be changed, webcam/microphone 224 may be changed, lift case cavity 270 may become side case cavity, back case cavity 262 may become side case cavity, back case cavity 272 may be adapted to become side case cavity, utilization of left and right upper stationary tips 263A,263B, top and lower flat surfaces 264A,264B, left and right flat holders 265A,265B, left and right protrusions 268A,268B and left and right lower stationary tips 273A,273B may be kept intact.

In use, the user would lift case cavity 270, lift out the mirror/webcam/microphone out of side mirror cavity 262, release the shaft flat surface 264B and while the shortened rotatable shaft 267 is turning 180 degrees towards the top side of a computer monitor or a laptop computer screen case at which case the side left and right shaft flat holders 265A and 265B engage and lock up with the side shaft flat surface 264A, and at the same time the left and right protrusions 268A,268B will be in contact with the left and right upper stationary tips 263A,263B. The mirror, along with the webcam/microphone, is now up and locked and is now ready for use. The process is reversed when storing the mirror back to its storage position inside the side mirror cavity and locking up the rotatable shaft's bottom shaft flat surface by the side left and right shaft flat holders, and by the side left and right lower stationary tips.

1. A utility mirror assembly, comprising:
a base having a base surface with an adhesive layer for contacting and adhering to a second surface;
a post, adjustable in length, congruent with the base and extending substantially orthogonally away from the base surface; and
a utility mirror having a reflective surface, incorporated in a frame attaching to the post at an end of the post away from the base by a limited universal pivot mechanism, allowing a range of angular adjustment between the utility mirror and the base surface.

2. The assembly of claim 1 wherein the second surface is a reflective surface of a rear-view mirror of a vehicle, and the utility mirror provides for viewing a blind spot not viewable in the reflective surface without angular adjustment of the reflective surface.

3. The assembly of claim 1 wherein the utility mirror has curvature for one or both of focus or magnification.

4. The assembly of claim 1 wherein the adjustable post is adjustable in length through an internally-threaded first portion engaging and externally-threaded second portion, and further comprises a locking mechanism for locking at a set length.

5. The assembly of claim 1 wherein the adjustable post is adjustable in length through a first portion having an internal bore of a first diameter, and a second portion with a post of substantially the diameter of the bore, the second portion engaging the bore, and further comprises a locking mechanism for locking at a set length.

6. The assembly of claim 1 wherein the second surface is a body surface or screen of a computer monitor, the utility mirror providing an adjustable view to the rear for a person viewing the computer display monitor.

7. The assembly of claim 6 wherein the post has an L-shape, such that the mirror assembly may be mounted on a side body surface of the display monitor, yet allowing direct viewing by the user viewing the monitor.

8. The assembly of claim 6 wherein the post has a C-shape, such that the mirror assembly may be mounted on a back body surface of the display monitor, yet allowing direct viewing by the user viewing the monitor.

9. The assembly of claim 1 wherein the adhesive layer comprises a male or female Velcro™ surface for mating with another Velcro™ surface.

10. The assembly of claim 2 wherein one or both of the reflective surface of the rear-view mirror and the utility mirror are angularly adjustable through remotely operated, motor-driven mechanisms.

11. The assembly of claim 2 wherein the rear-view mirror is one of a driver-side, a passenger side, or an internal rear-view mirror.
